(19) United States
(12) Patent Application Publication
(10) Pub. No.: US 2011/0182221 A1
(43) Pub. Date: Jul. 28, 2011

(54) HYBRID COMMUNICATION TERMINAL AND PROGRAM

(75) Inventor: TAKETOSHI ARAKAWA, Yokohama (JP)

(73) Assignee: Hitachi, Ltd.

(21) Appl. No.: 12/955,695

(22) Filed: Nov. 29, 2010

(30) Foreign Application Priority Data
Jan. 28, 2010 (JP) 2010-016860

(51) Int. Cl. H04W 36/00; H04W 52/02

(52) U.S. Cl. 370/311; 370/331

(57) ABSTRACT

When two networks are simultaneously connected on a side of a communication terminal by operating circuits corresponding to each of the two networks, the communication terminal requires about two times more power from a PC than a normal single terminal, resulting in a significant limitation in the number of interfaces to be used on the PC. Accordingly, in order to solve these problems, there is provided a mechanism for temporarily deactivating a major power consuming part of the circuit corresponding to the network currently connected to the communication terminal while measuring the wireless communication quality between the communication terminal and the other network, determining whether an inter-system handover is possible, and performing a handover from the current network to the other network when it is determined to be possible.

### CLAIM OF PRIORITY

The present application claims priority from Japanese patent application serial no. 2010-016860, filed on Jan. 28, 2010, the content of which is hereby incorporated by reference into this application.

### FIELD OF THE INVENTION

The present invention relates to a hybrid communication terminal connected to a computer and a program for the same. More particularly, the present invention relates to a hybrid communication terminal supplied with power from a computer and capable of performing a handover even while continuing to provide communication, and also to a program for the same.

### BACKGROUND OF THE INVENTION

A mobile communication system is a tool for voice communication services, wireless internet for low-capacity mobile devices, and email delivery services. Currently, it can also provide easy access to broadband mobile services based on the existing mobile network for 3G, in particular for 3.5G services, as well as new broadband mobile services such as WiMAX allowing further broadband communications. In addition, the environment for mobile communication systems is now in place, which is fully available for the broadband content represented by video streaming, even taking into account the reduction in communication speed caused by the Doppler Effect due to high speed movement.

As compared to the 3G network based on the existing mobile network, WiMAX, which is the new broadband mobile service, can provide high speed communication but currently has a limited service area, providing services on a spot basis. At this time WiMAX alone is still not available everywhere yet. Under these circumstances, there is a growing need for terminals to perform WiMAX communication in the environment available for high-speed WiMAX broadband services while automatically switching to the existing 3G network in the out of WiMAX service area.

Further, there is an increasing trend of more compact and lightweight PCs for the use of the mobile terminals. Because of this trend, interfaces connected to various I/O devices are also miniaturized and standardized. There is also a limitation of the built-in battery capacity due to the miniaturization, resulting in an environment in which there are widely used compact PCs only implementing interfaces capable of providing a low maximum power to the I/O.

In other words, there are more and more cases in which the user must select the PC according to the I/O device to be used. Naturally, the need for acquisition and exchange of information through a communication terminal is high even in the compact PC. However, the factors of high speed and low power consumption are kind of trade-off as a communication terminal, and there is a high demand for power saving of the communication terminal.

JP-A No. 236079/2008 describes a technology that enables a communication terminal to communicate the same data simultaneously with two different networks. The communication terminal starts a connection to a first network. The communication terminal monitors the wireless communication quality between the communication terminal and the first network. When the monitoring result is below a certain threshold of the wireless communication quality, the communication terminal connects to a second network. The communication terminal starts communication between the communication terminal and the second network with the same data as that of between the communication terminal and the first network. Similarly, the communication terminal monitors the wireless communication quality between the communication terminal and the second network. When it is confirmed that the wireless communication quality between the communication terminal and the second network exceeds a certain threshold and enables communication between them, the communication terminal disconnects the connection between the communication terminal and the first network to perform a handover.

JP-A No. 049875/2009 describes a technology that enables a communication terminal to communicate simultaneously with two different networks or with one of the two networks. The communication terminal connects to a first network. The communication terminal can obtain information about the communication quality between the communication terminal and the first network, the power consumption in the communication between the communication terminal and the first network, the communication speed between the communication terminal and the first network, and the used communication application. Similarly, the communication terminal can also obtain the information about the communication quality between the communication terminal and a second network. The communication terminal uses the monitoring values as parameters of a handover procedure. The communication terminal selects the network on the side enabling power saving in the range in which the used communication application can be used without any problems. Then, the communication terminal establishes a new connection to the power saving side, or performs a handover.

### SUMMARY OF THE INVENTION

### <Support is Currently Provided Only on the Terminal Side Due to the Delay in the System Definition>

In the conventional handover system between different networks, it is necessary to provide dedicated equipment not only on the terminal side but also on the side of each network to perform a handover.

In this case, it is necessary to provide a dedicated circuit for the communication terminal, and dedicated equipment for the network. When the support includes the network side equipment, it takes into account future system migration and easy roaming. Generally, it uses dedicated equipment that supports a method defined by standardization organizations, such as 3GPP and 3GPP2 for 3G network, and IEEE and WiMAX Forum for WiMAX.

In this case, the handover service for WiMAX and 3G networks will not be provided until the standardization organizations determine the specifications of the handover between the WiMAX and 3G networks. Further, the dedicated equipment on the network side is expensive, placing a heavy burden on the cost of equipment investment. In addition, the newly launched network, such as WiMAX, initially has a small service area. Thus, in general, the service is promoted by supporting roaming with existing networks. However, this is not likely to take place in the early stage.

### <Power Reduction is an Important Factor in the Support on the Terminal Side>

The specific requirements of the terminal side include: simultaneously connecting to the two different networks by the terminal side; comparing the wireless communication qualities of the two networks; selecting the network with a good environment; and constantly performing a handover to the network with the good environment. In order to simultaneously connect to the two networks by the terminal side, however, it is necessary to operate individual circuits for connecting to the two types of networks at the same time in the terminal. In this case, the power from the PC should be about two times the power to the normal single terminal.

However, when a wireless modem is connected to the PC, there are a very small number of general-purpose interfaces that can supply such a large amount of power. On the contrary, the production of a unique interface capable of supplying a large amount of power leads to a significant limitation of the type of PC to be used. As a result, the dissemination to the market is limited.

### <Technologies in the Prior Art>

As described in JP-A No. 236079/2008, in a state in which the communication terminal is connected to the first network, when the wireless communication quality between the communication terminal and the first network is below a certain threshold, the communication terminal connects to the second network. In this way, the communication terminal simultaneously connects to the different networks, transmitting the same data to the two networks. When the wireless communication quality between the communication terminal and the second network exceeds a certain threshold, the communication terminal performs a handover by disconnecting the connection to the first network. Then, the communication terminal connects to the other network. At this time, the individual circuits corresponding to the two different networks are operated at the same time in the communication terminal. Thus, the power consumption significantly increases in the high speed communication networks such as 3G and WiMAX.

In this case, there are a small number of interfaces that can be used in particular in the application of communication card or communication dongle (a small device connected to a PC) that operates with power supplied from the PC. In addition, such interfaces do not meet the current trend of power saving, and are not used in PC commonly available in the market.

Next, JP-A No. 049875/2009 describes when the communication terminal is connected to different networks. The communication terminal measures the power consumption of each connection. Then, the communication terminal performs a handover from one network to the other network enabling saving power, within the range in which the use of the application is not difficult. In this case, the communication terminal measures the power consumption when connected to a first network. Next, the communication terminal establishes connection to a second network and measures the power consumption, while maintaining the connection to the first network. Thus, from the point of view of power consumption this is the same as the case of JP-A No. 236079/2008 with respect to the process of measuring the power consumption.

In addition, it is necessary to measure in real time each value of parameters to be used as a handover determination factor. However, when circuits for measuring such values are mounted on a mobile device, there is a risk that the circuit scale will be increased. As a result, it is difficult to provide a configuration for achieving a compact terminal.

Consequently, the above problems may not be solved by the existing technologies.

To solve the above problems, according to the present invention, the wireless communication qualities of different networks are obtained from individual communication functional units in the communication terminal that correspond to the respective networks, by an application mounted on a PC. The wireless communication quality of each network is checked by the application of the PC, to connect as much as possible to the priority network set by the user at the time of new connection.

Further, the handover between the different systems is led by the application mounted on the PC. This makes it possible to reduce the scale of the dedicated circuits in the communication terminal. In addition, there is no influence of the standardization movement.

Further, in the state in which the communication terminal is connected to one of the two different networks, when the wireless communication quality between the communication terminal and the one of the two different networks is determined to be insufficient to maintain the current connection, or determined to satisfy certain conditions, the communication terminal temporarily deactivates the major power consuming functional unit in the circuit that corresponds to the network currently connected to the communication terminal. During the deactivation phase, the communication terminal measures the wireless communication quality between the communication terminal and the other network. In this mechanism, if it is determined that an inter-system handover is possible, the communication terminal performs a handover from the current network to the other network, based on the destination of the possibility of the handover.

In this case, the scale and power consumption of the circuits driven at the same time in the communication terminal are substantially equal to those of the single communication terminal only supporting communication with only the communication system on one side. As a result, the handover is not likely to be influenced by the maximum power consumption requirements specific to each interface supported by the PC.

Thus, an aspect of the present invention is a hybrid communication terminal capable of connecting to a first wireless network and a second wireless network, and of controlling a handover from the first wireless network to the second wireless network. The hybrid communication terminal includes a first functional unit for connecting to the first wireless network, a second functional unit for connecting to the second wireless network, and a hub for connecting the first and second functional units to a computer. The first and second functional units obtain connection states of the first and second wireless networks, respectively. Then, the first and second functional units transmit the obtained connection states to the computer, respectively.

Another aspect of the present invention is a hybrid communication terminal capable of simultaneously connecting to a first wireless network and a second wireless network. The hybrid communication terminal includes a first modem unit and a first RF band unit for connecting to the first wireless network, as well as a second modem unit and a second RF band unit for connecting to the second wireless network. In a state of waiting for the first wireless network, the hybrid communication terminal deactivates transmission units of the first modem unit and the first RF band unit while activating reception units of the second modem unit and the second RF band unit. Then, the hybrid communication terminal monitors a state of the second wireless network.

Still another aspect of the present invention is a program for causing a computer to function as a state monitoring unit of a first network, a state monitoring unit of a second network, and a handover controller for determining and controlling a handover from the first network to the second network, based on a first determination result of the state monitoring unit of the first network, and based on a second determination result of the state monitoring unit of the second network.

According to the present invention, it is possible to support a large number of PC interfaces in a communication terminal that operates with power supplied from a PC. As a result, the communication terminal can be used with common PC. Also in a communication terminal of handset type not receiving power from a PC, the total amount of power consumption is reduced. As a result, it is possible to increase the lifetime of the built-in battery of the communication terminal.

### BRIEF DESCRIPTION OF THE DRAWINGS

Preferred embodiments of the present invention will now be described in conjunction with the accompanying drawings, in which;

FIG. 1 is a block diagram of a wireless network;

FIG. 2 is a functional block diagram of a hybrid communication terminal and a hardware block diagram of a PC;

FIG. 3 is a functional block diagram of the PC;

FIG. 4 shows a GUI screen of an inter-system handover control user interface;

FIG. 5A is a sequence diagram for illustrating a handover from a WiMAX network to a 3G network (part 1);

FIG. 5B is a sequence diagram for illustrating the handover from the WiMAX network to the 3G network (part 2);

FIG. 6 is a time chart for illustrating the control switching of wireless transmission/reception units in a state transition from power ON to WiMAX waiting with WiMAX as the priority network;

FIG. 7 is a time chart for illustrating the control switching of the wireless transmission/reception units in a state transition from WiMAX waiting to WiMAX communication with WiMAX as the priority network;

FIG. 8 is a time chart for illustrating the control switching of the wireless transmission/reception units in a state transition from WiMAX communication to 3G communication with WiMAX as the priority network;

FIG. 9 is a time chart for illustrating the control switching of the wireless transmission/reception units in a state transition from 3G communication to WiMAX communication with WiMAX as the priority network;

FIG. 10 is a time chart for illustrating the control switching of the wireless transmission/reception units in a state transition from WiMAX communication to WiMAX waiting with WiMAX as the priority network;

FIG. 11 is a time chart for illustrating the control switching of the wireless transmission/reception units in a state transition from WiMAX waiting to 3G communication through WiMAX communication failure, with WiMAX as the priority network;

FIG. 12 is a time chart for illustrating the control switching of the wireless transmission/reception units in a state transition from 3G communication to 3G communication again through WiMAX hand-up, with WiMAX as the priority network;

FIG. 13 is a time chart for illustrating the control switching of the wireless transmission/reception units in a state transition from 3G communication to WiMAX waiting with WiMAX as the priority network;

FIG. 14 is a time chart for illustrating the control switching of the wireless transmission/reception units in a state transition from power ON to 3G waiting with 3G as the priority network;

FIG. 15 is a time chart for illustrating the control switching of the wireless transmission/reception units in a state transition from power ON to 3G waiting with 3G as the priority network;

FIG. 16 is a time chart for illustrating the control switching of the wireless transmission/reception units in a state transition from power ON to 3G waiting with 3G as the priority network;

FIG. 17 is a time chart for illustrating the control switching of the wireless transmission/reception units in a state transition from power ON to 3G waiting with 3G as the priority network;

FIG. 18 is a time chart for illustrating the control switching of the wireless transmission/reception units in a state transition from power ON to 3G waiting with 3G as the priority network;

FIG. 19 is a view of an RF control sequence of the 3G functional unit, the system handover control user interface, and the WiMAX functional unit (part 1);

FIG. 20 is a view of the RF control sequence of the 3G functional unit, the system handover control user interface, and the WiMAX functional unit (part 2);

FIG. 21 is a view of the RF control sequence of the 3G functional unit, the system handover control user interface, and the WiMAX functional unit (part 3);

FIG. 22 is a view of the RF control sequence of the 3G functional unit, the system handover control user interface, and the WiMAX functional unit (part 4);

FIG. 23 is a view of the RF control sequence of the 3G functional unit, the system handover control user interface, and the WiMAX functional unit (part 5); and

FIG. 24 is a view of the RF control sequence of the 3G functional unit, the system handover control user interface, and the WiMAX functional unit (part 6).

### DETAILED DESCRIPTION OF THE PREFERRED EMBODIMENT

Hereinafter embodiments of the present invention will be described by way of examples with reference to the annexed drawings. Like or corresponding parts are denoted by the same reference numerals and the description will not be repeated. In the following description, 3G and WiMAX are taken as an example of two types of wireless networks. However, the two types of wiring networks are not limited to the above examples.

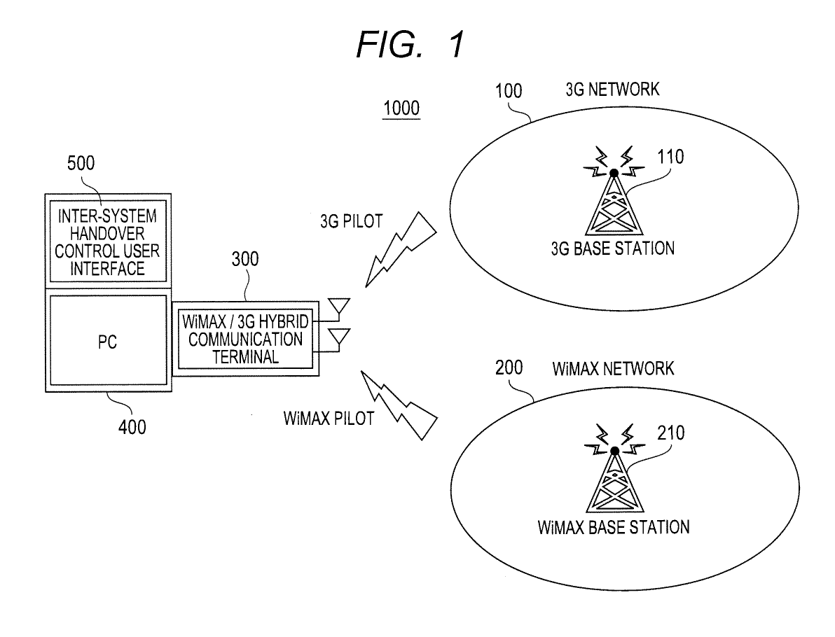

First, the configuration of a wireless network 1000 will be described with reference to FIG. 1. In FIG. 1, the wireless network 1000 includes a WiMAX/3G_hybrid communication terminal 300 connected to a personal computer (PC) 400, a 3G network 100, and a WiMAX network 200. When the WiMAX/3G_hybrid communication terminal 300 is first connected to the PC 400, the PC 400 uses Zero Install to install an inter-system handover control user interface 500. The 3G network 100 includes a 3G base station 110. The WiMAX network 200 includes a WiMAX base station 210.

Hereinafter, the WiMAX/3G_hybrid communication terminal 300 is simply referred to as the hybrid communication terminal 300. Further, the inter-system handover control user interface 500 is simply referred to as the control user interface 500. This is to prevent an increase in the volume of the specification.

### <Initial Connection Operation>

Once mounted on the PC 400, the hybrid communication terminal 300 receives power supply from the PC 400. The hybrid communication terminal 300 tries to capture the priority connection network that has been set by the user to the control user interface 500. The hybrid communication terminal 300 moves to a waiting state in the particular system.

The control user interface 500 confirms that the hybrid communication terminal 300 is normally recognized by the PC 400. Then, the control user interface 500 transmits an instruction to the hybrid communication terminal 300 to periodically report various states of both the WiMAX network 200 and the 3G network 100. The control user interface 500 monitors the connection states of the individual networks 100 and 200 in real time.

### <Communication Start Operation>

The control user interface 500 issues a connection instruction to the hybrid communication terminal 300 by an operation of the user. The control user interface 500 confirms the priority connection that has been set by the user, and connects to the 3G network 100 or to the WiMAX network 200 according to the connection mode.

It is to be noted that the connection mode, which has been set by the user to the control user interface 500, is selected from the following two modes. One is the mode for priority connection to the 3G network 100 or to the WiMAX network 200, and the other one is the mode for connection to only one of the 3G network 100 or the WiMAX network 200.

### <Handover Operation>

Under the following conditions, the control user interface 500 transmits an instruction to the hybrid communication terminal 300 to deactivate the major power consuming portion of the circuit corresponding to the currently connected network in the hybrid communication terminal 300.

Condition 1: In a state of connecting to the priority network, the communication wireless quality of the connected network is reduced, satisfying the condition for starting handover.

Condition 2: In a state of connecting to the non-priority network, the state of the connected network is waiting (WiMAX idle state, 3G dormant state) without communication.

The hybrid communication terminal 300 receives the instruction to deactivate the major power consumption portion. Then, the hybrid communication terminal 300 moves the particular portion to an inactive state. The hybrid communication terminal 300 notifies the control user interface 500 of the completion of the transition to the inactive state. The control user interface 500 receives the notification of inactive state transition completion from the hybrid communication terminal 300. Then, the control user interface 500 transmits an instruction to the hybrid communication terminal 300, to activate the circuit corresponding to the network in the waiting state, the WiMAX network 200 or the 3G network 100.

In order to prevent an infinite loop in inter-system handover, the hybrid communication terminal 300 does not perform a handover during communication if it is the case from the non-priority network to the priority network. At the time when the non-priority network moves to the waiting state without communication, the hybrid communication terminal 300 activates the portion of the circuit corresponding to the priority network based on an activation instruction from the control user interface 500.

The hybrid communication terminal 300 activates the circuit supporting to the WiMAX network 200 or the 3G network 100. The hybrid communication terminal 300 reports the wireless communication quality of the handover destination, the WiMAX network 200 or the 3G network 100, to the control user interface 500. The control user interface 500 determines whether the received wireless communication quality satisfies the condition for performing a handover. When the condition is satisfied, the control user interface 500 transmits an instruction to the hybrid communication terminal 300 to execute the handover.

Upon receiving the handover execution instruction, the hybrid communication terminal 300 establishes a connection to the WiMAX network 200 or to the 3G network 100. The hybrid communication terminal 300 notifies the control user interface 500 of the result.

When the connection is established, the control user interface 500 transmits a request to the hybrid communication terminal 300 to clear the session information with the handover source, the WiMAX network 200 or the 3G network 100. The control user interface 500 displays a message indicating that the connected network is changed, on a user interface 510 of the control user interface 500. The control user interface 500 continues monitoring the state of the currently connected network.

If the connection fails to be established, the hybrid communication terminal 300 tries to reconnect to the handover source, the WiMAX network 200 or the 3G network 100.

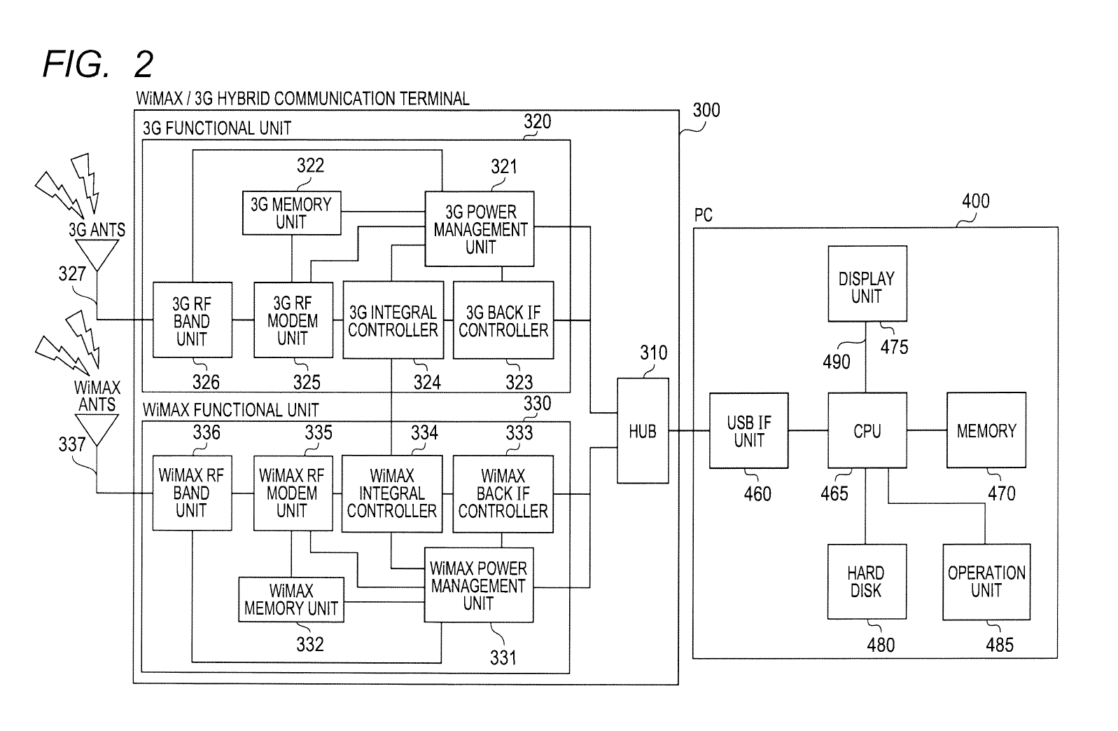

The configuration of the hybrid communication terminal 300 and the configuration of the PC 400 will be described with reference to FIG. 2. The hybrid communication terminal 300 includes a hub 310, a 3G functional unit 320, and a WiMAX functional unit 330. The 3G functional unit 320 includes a 3G power management unit 321, a 3G memory unit 322, a 3G back IF controller 323, a 3G integral controller 324, a 3G modem unit 325, a 3G RF band unit 326, and a 3G antenna 327. The WiMAX functional unit 330 includes a WiMAX power management unit 331, a WiMAX memory unit 332, a WiMAX back IF controller 333, a WiMAX integral controller 334, a WiMAX modem unit 335, a WiMAX RF band unit 336, and a WiMAX antenna 337.

The hub 310 connects both the 3G functional unit 320 and the WiMAX functional unit 330 to the PC 400.

In the 3G functional unit 320, the 3G integral controller 324, the 3G modem unit 325, and the 3G RF band unit 326 are each divided into two parts: a transmission unit and a reception unit. Each of the transmission and reception units is subjected to power supply control by the power management unit 321.

Also in the WiMAX functional unit 330, the WiMAX integral controller 334, the WiMAX modem unit 335, and the WiMAX RF band unit 336 are each divided into two parts: a transmission unit and a reception unit. Each of the transmission and reception units is subjected to power supply control by the power management unit 331.

The PC 400 includes a USB IF unit 460, a CPU 465, a memory 470, a display unit 475, a hard disk 480, an operation unit 485, and an internal communication line 490 for connecting the respective components.

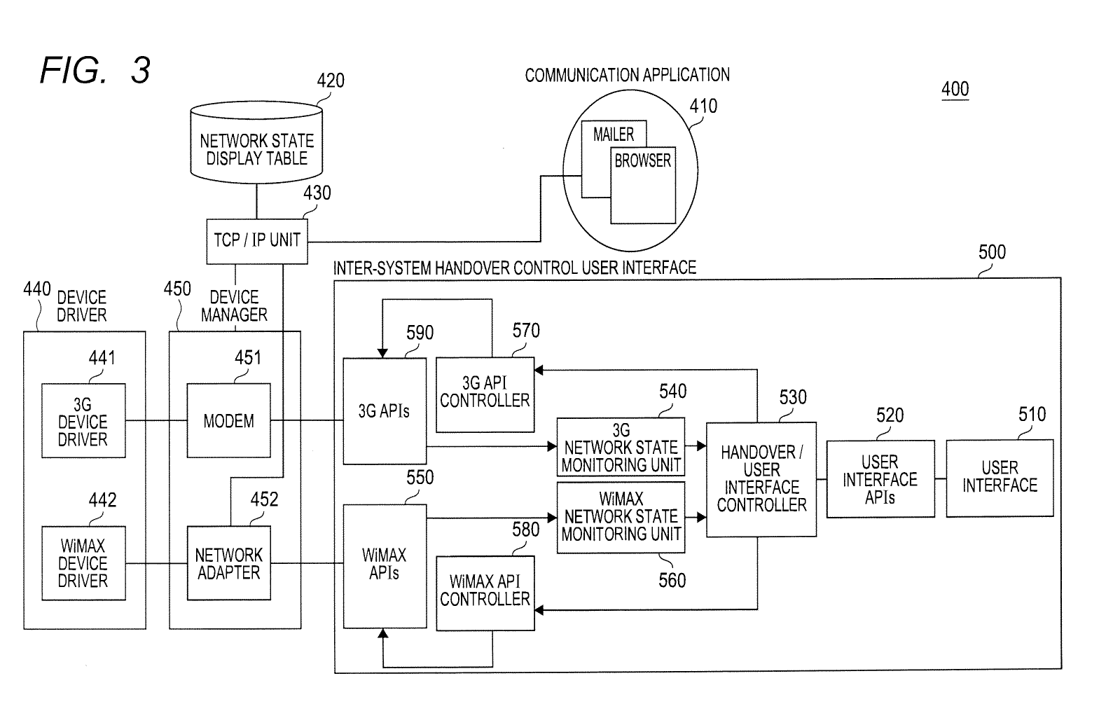

The functional block of the PC 400 will be described with reference to FIG. 3. In FIG. 3, the PC 400 includes a communication application 410 (more specifically, an Internet browser and a mailer), a connected network state table 420, a TCP/IP unit 430, a device driver 440, a device manager 450, and an inter-system handover control user interface 500.

The device driver 440 includes a 3G device driver 441 and a WiMAX device driver 442. The device manager 450 includes a modem 451 and a network adopter 452. The control user interface 500 includes a user interface 510, user interface application program interfaces (APIs) 520, a handover/user interface controller 530, a 3G network state monitoring unit 540, a WiMAX network state monitoring unit 560, a 3G API controller 570, a WiMAX API controller 580, 3G APIs 590, and WiMAX APIs 550.

The device manager 450 functions in the connection modes, connection to the 3G functional unit 320 and connection to the WiMAX functional unit 330. More specifically, the 3G functional unit 320 is recognized as a modem 421 and the WiMAX functional unit 330 is recognized as a network adopter in the device manager 450.

The user interface 510 is operated by the user to provide the state display of the WiMAX network 200 and the 3G network 100, various settings, and connection/disconnection control. The individual functions of the user interface 510 correspond to the user interface APIs 520. The handover/user interface controller 530 has the interface function of the user interface APIs 520, the 3G APIs 590, and the WiMAX APIs 550. In addition, the handover/user interface controller 530 finally determines the execution of the handover and which one of the networks should be connected when a new connection is established.

The 3G network state monitoring unit 540 monitors the wireless communication quality of each system as well as the state (connection/disconnection/waiting/pilot capture or the like) of the 3G functional unit 320, based on the response message from the 3G APIs 590. When the state is changed, the 3G network state monitoring unit 540 notifies the handover/user interface controller 530.

The WiMAX network state monitoring unit 560 monitors the wireless communication quality of each system as well as the state (connection/disconnection/waiting/pilot capture or the like) of the WiMAX functional unit 330, based on the response message from the WiMAX APIs 550. When the state is changed, the WiMAX network state monitoring unit 560 notifies the handover/user interface controller 530.

The 3G API controller 570 executes the 3G APIs 590 based on the instruction from the handover/user interface controller 530. As a result, the 3G API controller 570 controls the 3G functional unit 320. The WiMAX API controller 580 executes the WiMAX APIs 550 based on the instruction from the handover/user interface controller 530. As a result, the WiMAX API controller 580 controls the WiMAX functional unit 330.

As is apparent from the comparison between FIG. 2 and FIG. 3, the CPU 465 executes the program on the memory 470 to realize each of the functions of the controllers and of the APIs in the inter-system handover control user interface 500.

### <Initial Connection Operation (Connecting to the Priority Network>

When the hybrid communication terminal 300 is connected to the PC 400, the PC communicates with the back IF controllers 323/333 of the 3G functional unit 320 and of the WiMAX functional unit 330. Then, the PC 400 selects the corresponding device drivers. Then, the PC 400 implements the device types corresponding to the individual devices under the device manager 450. In this way, the device recognition is completed.

Upon completion of the device recognition, the control user interface 500 transmits the priority setting information, which has been set by the user, to the 3G functional unit 320 and to the WiMAX functional unit 330 through the device driver 440.

Based on the priority setting information, the priority network side, the 3G integral controller 324 or the WiMAX integral controller 334 prepares the connection setting to the WiMAX network 200 or to the 3G network 100 through the antenna 327 or the antenna 337. Then, the state moves to the waiting state.

Basically, the non-priority network moves to the inactive state. The 3G integral controller 324 or the WiMAX integral controller 334 instructs the corresponding functional unit 320/330 to prevent operation of the major power consuming functional unit. Then, the state is changed to the inactive state.

It is to be noted that the power consumption of the hybrid communication terminal 300 can be controlled in several stages by changing the range of deactivation. The operation will be specifically described in several cases below.

### <Deactivation Only Transmission of the RF Band Unit>

Only wireless transmission of the 3G RF band unit 326 or of the WiMAX RF band unit 336 is not performed. The wireless transmission can be prevented in the 3G RF band unit 326 or in the WiMAX RF band unit 336 in the following way. That is, the WiMAX integral controller 334 or the 3G integral controller 324 instructs the 3G power management unit 321 or the WiMAX power management unit 331 to turn OFF the power to the transmission unit of the 3G RF band unit 326 or to the transmission unit of the WiMAX RF band unit 336.

In general, the transmission RF band unit is the major power consuming block in each system. By deactivating only the transmission side of the system which is not in the connection state, it is possible to substantially reduce the power consumption necessary for the system. However, the reception side of the particular system can continue the operation. As a result, it is possible to continue the state monitoring of the particular system while limiting the power consumption.

When the deactivated system is in the connection state, the 3G modem unit 325 or the WiMAX modem unit 335 ignores all the messages expecting a response, with respect to the messages received from the WiMAX network 200 or from the 3G network 100. It is because the 3G modem unit 325 or the WiMAX modem unit 335 is instructed to do so by the WiMAX integral controller 334 or by the 3G integral controller 324. However, the WiMAX modem unit 335 or the 3G modem unit 325 recognizes the reception of the messages. The WiMAX modem unit or the 3G modem unit 325 is not in the state being unable to physically receive radio waves as it is in a tunnel or under the shade of a building. Thus, the phenomenon of high output signal transmission does not occur at the time of the transition from the inactive state to the active state, by the power control from the base station 110/210.

### <Deactivation of Transmission/Reception of the RF Band Unit>

In order to prevent wireless transmission/reception in the 3G RE band unit 326 or in the WiMAX RF band unit 336, the WiMAX integral controller 334 or the 3G integral controller 324 instructs the 3G power management 321 or the WiMAX power controller 331 to turn off the power to the 3G RF band unit 326 or to the WiMAX RF band unit 336.

In this case, the wireless layer is deactivated on both the transmission and reception sides, and does not receive the power control instruction from the base station 110/210 during the period of the inactive state. As a result, it is possible to prevent high output signal transmission at the time of the transition from the inactive state to the active state, by the power control from the base station 110/210.

### <Deactivation of All Communication Functions>

Further, in order to turn off all the communication functions of the 3G functional unit 320 or of the WiMAX functional unit 330, the WiMAX integral controller 334 or the 3G integral controller 324 instructs the 3G power management unit 321 or the WiMAX power management unit 331 to turn off the power to the 3G modem unit 325 and the 3G RF band unit 326, or to the WiMAX modem unit 325 and the WiMAX RF band unit 336.

In this case also, the wireless layer is deactivated on both the transmission and reception sides, and does not receive the power control instruction from the base station 110/210 during the period of the inactive state. As a result, it is possible to prevent high output signal transmission at the time of the transition from the inactive state to the active state, by the power control from the base station 110/210.

It is to be noted that in the inactive states described above, the larger the range of deactivation is, the more the power consumption of the entire hybrid communication terminal 300 can be reduced. On the other hand, the time of the transition from the inactive state to the active state is increased. For this reason, the appropriate deactivation range is selected according to the interface specifications of the PC 400 that the WiMAX/3G handover terminal should support. In this way, it is possible to achieve effective power saving without too much reducing the performance.

### <Initial Connection Operation (Connecting to the Non-Priority Network)>

If the priority network is out of service, the control user interface SOO transmits an instruction to the 3G functional unit 320 and to the WiMAX functional unit 330 through the hub 310 to deactivate the priority network side and activate the non-priority network side. The hybrid communication terminal 300 waits on the non-priority network side. At this time, when the hybrid communication terminal 300 waits on the non-priority network side, the control user interface 500 checks whether the priority network moves from the out of service state to the in service state with an arbitrary interval. In other words, the control user interface 500 transmits an instruction to the 3G integral controller 324 and to the WiMAX integral controller 334, respectively, to move their functional units previously determined to be inactive, from the active state to the inactive state or from the inactive state to the active state. In this way, the control user interface 500 sequentially determines whether it is possible to wait on the priority side. At the same time, the control user interface 500 activates only the reception unit of each functional unit to reduce the power consumption necessary for the state determination.

When the priority network is changed to the out of service state, the control user interface 500 activates the functional unit previously determined to be inactive in the 3G functional unit 320 or in the WiMAX functional unit 330, corresponding to the priority network side. Then, the control user interface 500 waits on the priority network side.

### <Communication Start Operation>

Next, the connection operation will be described. First, the user makes a connection request through the user interface 510. Then, the control user interface 500 transmits a connection instruction to the functional unit in the waiting state, which is the 3G functional unit 320 or the WiMAX functional unit 330, through the device driver 440 and the hub 310. On the waiting side of either the 3G functional unit 320 or the WiMAX functional unit 330, 3G back IF controller 323 or the WiMAX back IF controller 333 receives the connection instruction from the control user interface 500. The 3G back IF controller 323 or the WiMAX back IF controller 333 transfers the content of the connection instruction to the WiMAX integral controller 334 or to the 3G integral controller 324. The WiMAX integral controller 334 or the 3G integral controller 324 controls the 3G modem unit 325 and the 3G RF band unit 326, or the WiMAX modem unit 335 and the WiMAX RF band unit 336. In this way, the connection is established to the WiMAX network 200 or to the 3G network 100.

### <Handover Operation>

Next, once the network connection is established, the control user interface 500 starts monitoring the wireless communication quality and the connection state during the connection phase. It is to be noted that the functions of waiting state monitoring, new connection, and inter-system handover control are all performed by the control user interface 500.

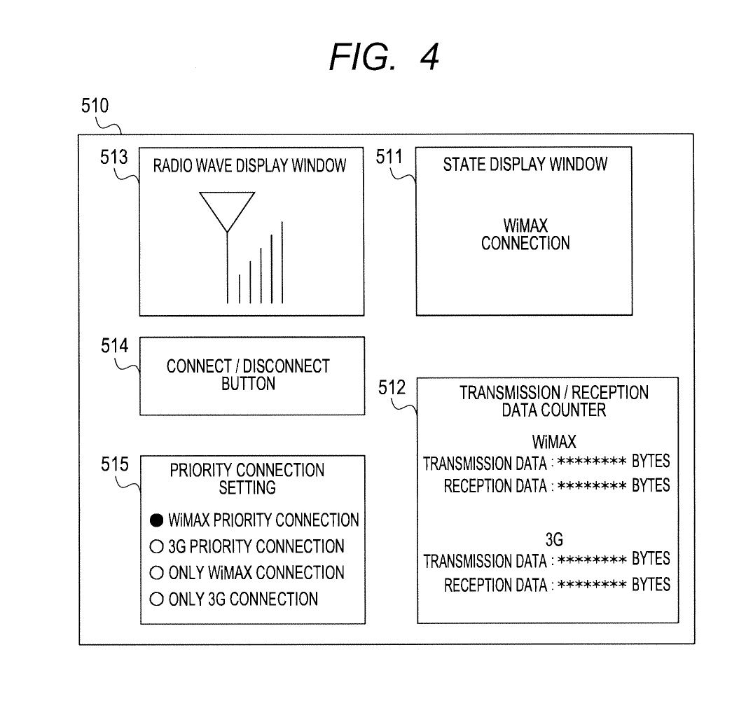

The GUI screen of the user interface 510 will be described with reference to FIG. 4. In FIG. 4, the user interface 510 includes a state display window 511, a transmission/reception data counter 512, a radio wave display window 513, a connect/disconnect button 514, and a priority connection setting 515.

The state display window 511 is a window that shows which network is in the waiting state or in the connection state. The transmission/reception data counter 512 is a window that shows the amount of data transmitted and received between the WiMAX network 200 and the WiMAX/3G handover terminal 300, and between the 3G network 100 and the WiMAX/3G handover terminal 300. The radio wave display window 513 displays the wireless communication quality of the WiMAX network 200 or of the 3G network 100, each of which is either in the waiting state or in the connection state. The connect/disconnect button 514 is a button that controls connection/disconnection to the WiMAX network 200 or to the 3G network 100. The priority connection setting 515 includes a mode for priority connection to the WiMAX, a mode for priority connection to the 3G, a mode for connection only to WiMAX, and a mode for connection only to 3G.

The above functions correspond to the respective user interface APIs 520 on a one-to-one basis.

The inter-system handover control is performed by the hybrid communication terminal 300. More specifically, the functional units previously determined to be inactive in the 3G functional unit 320 and in the WiMAX functional unit 330, corresponding to the WiMAX network 200 and to the 3G network 100, are switched between the active/inactive states within the hybrid communication terminal 300. In this way, it is possible to perform the handover while saving the power consumption. However, when the deactivation range should be applied even to the 3G modem unit 325 or the WiMAX modem unit 335, it is difficult to keep the communication state as the communication terminal. In this case, the disconnection information is notified to the PC 400 from the hybrid communication terminal 300. Then, the user application displays the network disconnection immediately after the OS discards the IP address assigned by the network side.

In other words, when the deactivation range should be applied even to the 3G modem unit 325 or to the WiMAX modem unit 335, it is difficult to keep the connectivity during the inter-system handover operation. However, with respect to the TCP application (more specifically, the Internet), a dummy address is assigned to the OS by the 3G device deriver 441 or by the WiMAX device driver 442 while the IP address is discarded by the OS. In this way, it is possible to keep the TCP session. When the inter-system handover is completed during the TCP retry period, the user application does not display the disconnection notification.

### <Operation of IP Address Complementary Function>

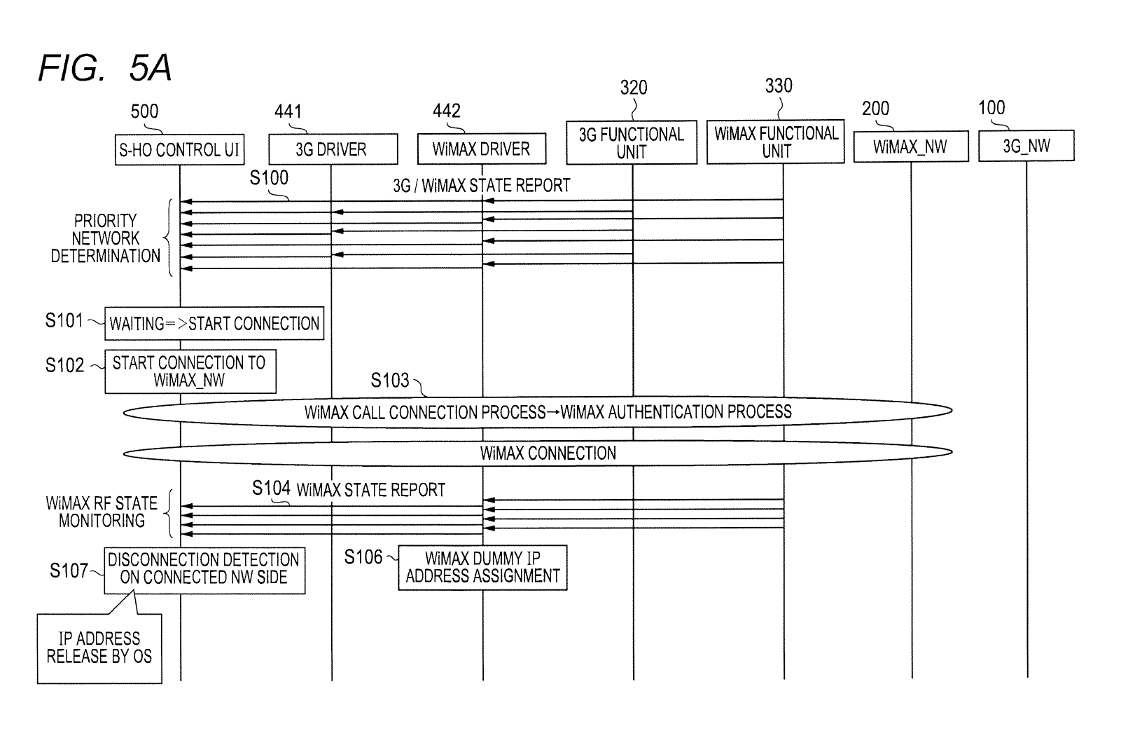

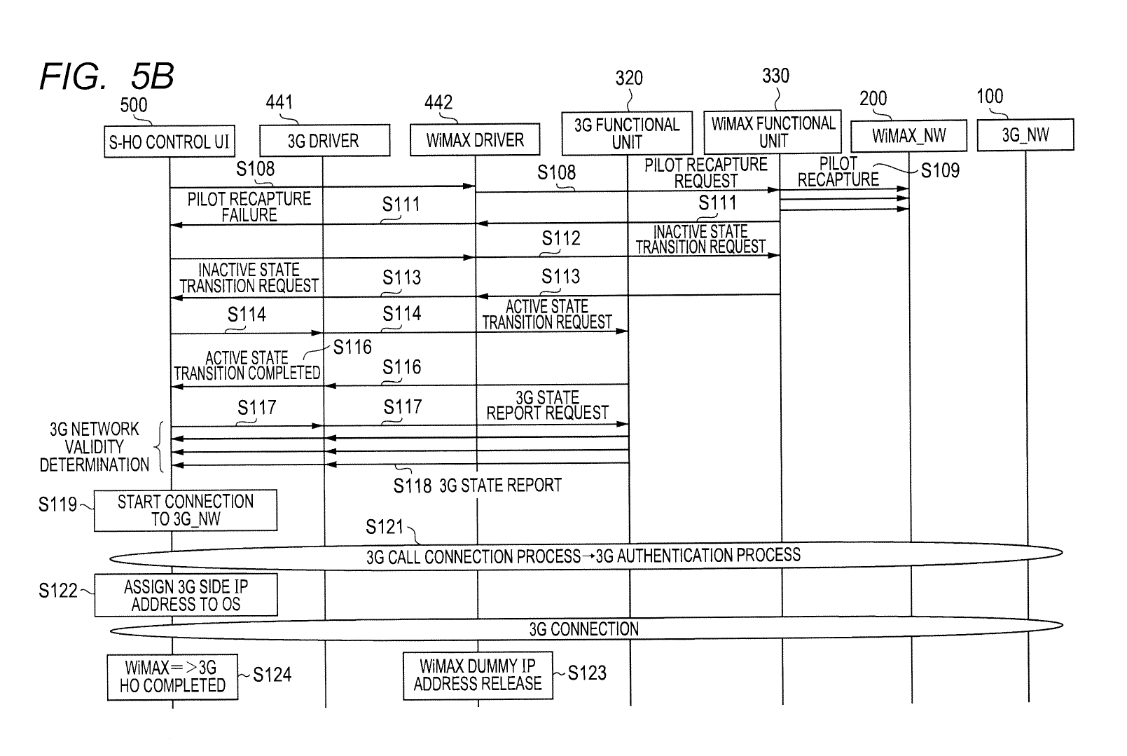

The IP address complementary function will be described with reference to FIG. 5. In FIG. 5, The 3G functional unit 320 and the WiMAX functional unit 330 periodically transmit a state report message to the control user interface 500, respectively, through the 3G device driver 441 and the WiMAX device driver 442 (S100). The control user interface 500 changes the display from the waiting state to the connection start state (S101). The control user interface 500 starts connection to the WiMAX network 200 (S102). The control user interface 500, the WiMAX functional unit 330, and the WiMAX network 200 perform WiMAX call connection process and WiMAX authentication process (S103). Then, the state moves to WiMAX connection. The WiMAX functional unit 330 periodically transmits a state report message to the control user interface 500 through the WiMAX device driver 442 (S104).

Here, it is assumed that disconnection occurs in the communication with the WiMAX network. The WiMAX device driver 442 detects a disconnection of the communication, and assigns a dummy IP address to the OS (S106). The control user interface 500 detects the disconnection of the connected network (S107). As a result of step 107, the IP address is released by the OS. The control user interface 500 transmits a pilot recapture request to the WiMAX functional unit 330 through the WiMAX device driver 442 (S108). The WiMAX functional unit 330 transmits the pilot recapture request several times to the WiMAX network 200 (S109).

The WiMAX functional unit 330 transmits a pilot recapture failure to the control user interface 500 through the WiMAX device driver 442 (S111). The control user interface 500 transmits an inactive state transition request to the WiMAX functional unit 330 through the WiMAX device deriver 442 (S112). The WiMAX functional unit 330 transmits an inactive state transition completion message to the control user interface 500 through the WiMAX device driver 442 (S113).

The control user interface 500 transits an active state transition request to the 3G functional unit 320 through the 3G device driver 441 (S114). The 3G functional unit 320 transmits an active state transition completion message to the control user interface 500 through the 3G device driver 441 (S116). The control user interface 500 transmits a 3G state report request to the 3G functional unit 320 through the 3G device driver 441 (S117). The 3G functional unit 320 periodically transmits the 3G state report to the control user interface 500 through the 3G device driver 441 (S118).

The control user interface 500 starts to establish a connection to the 3G network 100 (S119). The control user interface 500, the 3G functional unit 320, and the 3G network 100 perform 3G call connection process and 3G authentication process (S121). The control user interface 500 assigns the 3G side IP address to the OS (S122). Then, the state moves to 3G connection.

The WiMAX device driver 442 detects the IP address assignment to the OS, and releases the dummy IP address assigned in step 107 (S123). The control user interface 500 displays “WiMAX=>3G handover completed” on the user interface 510 (S124).

During the period of waiting, the inter-system handover control user interface 500 periodically receives 3G/WiMAX state display reports from the WiMAX functional unit 330 and the 3G functional unit 320 through the 3G device driver 441 and the WiMAX device driver 442. Based on the contents of the messages, the connection to the priority network is maintained. When it is difficult to maintain the priority network connection, the control user interface 500 continues to periodically determine whether it is possible to connect to the priority network while waiting on the non-priority network side.

It is assumed that the WiMAX network 200 is set as the priority network. In this case, when the control user interface 500 receives a connection instruction from the user, the state of the WiMAX/3G hybrid communication terminal 300 changes to the state of WiMAX network connection start. Then, the state moves to WiMAX network connection through the WiMAX call connection process and WiMAX authentication process S103.

Next, when the WiMAX/3G hybrid communication terminal 300 is in the connection state, the control user interface 500 and the WiMAX device driver 442 periodically receive a WiMAX state report that shows the state of the connection between the hybrid communication terminal 300 and the WiMAX network 200, from the WiMAX functional unit 330, in order to monitor the wireless communication quality as well as the state of the WiMAX functional unit.

When the call is disconnected during the connection state, the WiMAX device driver 442 assigns a WiMAX dummy IP address to the OS. The control user interface 500 detects from the WiMAX state report that the state of the connection to the WiMAX network is changed to disconnection. Then, the OS releases the IP address.

Next, the control user interface 500 transmits a pilot recapture request message of the WiMAX network 200, to the WiMAX functional unit 330. The WiMAX functional unit 300 performs pilot recapture with respect to the WiMAX network 200. When the pilot recapture is not successful with respect to the WiMAX network 200 after a predetermined number of executions of the recapture process, the WiMAX functional unit 330 transmits a pilot recapture failure message to the control user interface 500.

Upon receiving the pilot recapture failure message, the control user interface 500 gives up the recapture of the WiMAX network 200, and transmits an inactive state transition request message to the WiMAX functional unit 330. In response to the message, the WiMAX functional unit 330 deactivates the functional unit previously determined to be inactive. Then, the WiMAX functional unit 330 transmits an inactive state transition completion message to the control user interface 500.

Next, the control user interface 500 transmits an active state transition request message to the 3G functional unit 320. Upon receiving the active state transition request message, the 3G functional unit 320 activates the functional unit previously determined to be inactive. Then, the 3G functional unit 320 transmits an active state transition completion message to the control user interface 500.

Next, the control user interface 500 transmits a 3G state report request message to the 3G functional unit 320.

Upon receiving the 3G state report request message, the 3G functional unit 320 periodically transmits a 3G state report message to the control user interface 500. Next, when the validity of the 3G network is determined by the control user interface 500, the state of the 3G functional unit 320 moves to connection start to 3G network. Then, the state changes to 3G network connection through the 3G call connection process and 3G authentication process.

Next, once the connection to the 3G network 100 is established, an IP address is assigned to the OS by the 3G network 100. Immediately after the IP address is assigned, the WiMAX device driver 442 releases the WiMAX dummy IP address. The control user interface 500 completes the operation of the handover from the WiMAX network 200 to the 3G network 100.

The above embodiment has described the hand-off (hand-down) from the WiMAX network 200 to the 3G network 100. In the case of the hand-off (hand-up) from the 3G network 100 to the WiMAX 200, the 3G device driver 441 assigns a 3G dummy IP address. Then after completion of the hand-off to the WiMAX network 200, the 3G device driver 441 releases the 3G dummy IP address.

According to the embodiment described above, the device driver of the hand-off source detects disconnection of the call, and assigns a dummy IP address to the OS. Further, the device driver detects the assignment of an IP address to the OS, and releases the dummy IP address. In the handover operation, the hand-off source device driver receives the IP address assignment of the hand-off destination during repeated access to the dummy IP address. As a result, communication disconnection due to the hand-off does not occur.

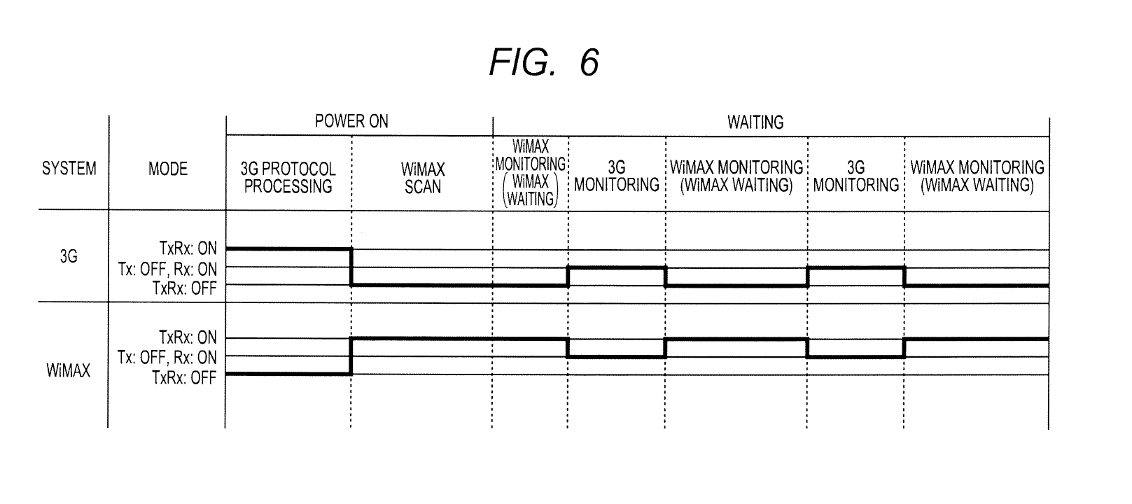

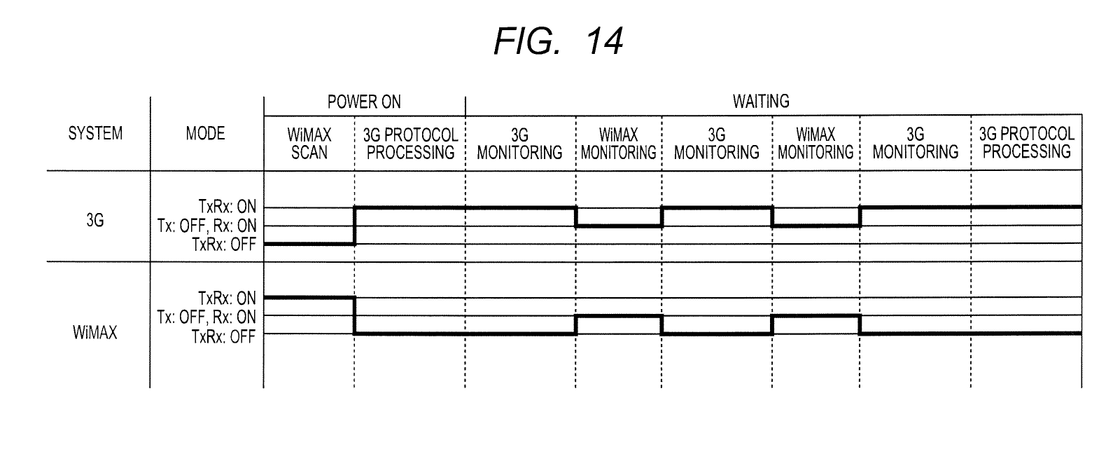

Control switching of the wireless transmission/reception units in state transition will be described with reference to FIGS. 6 to 18. Here, FIGS. 6 to 13 are views for illustrating the control switching of the wireless transmission/reception units in state transition with WiMAX as the priority network. FIGS. 14 to 18 are views for illustrating the control switching of the wireless transmission/reception units in state transition with 3G as the priority network. In FIGS. 6 to 13, the horizontal axis represents the time and the vertical axis represents the power consumption of the modem units 325, 335 and the RF band units 326, 336. It is to be noted that the time axis is not proportional to the length of the time interval.

The control mode of the vertical axis has the following three types: TxRx: ON, Tx: OFF Rx: ON, and TxRx: OFF. TxRx: ON is the state in which the reception and transmission units are both valid in the modem units 325, 335 and in the RF band units 326, 336. TxRx: ON is a control mode in which both transmission and reception are possible and protocol process is performed. Tx: OFF Rx: ON is the state in which only the reception unit is valid in the modem units 325, 335 and the RF band units 326, 336. Tx: OFF Rx: ON is a control mode in which only reception is possible and no protocol process is performed. TxRx: OFF is the state in which both the reception and transmission units are invalid in the modem units 325, 335 and in the RF band units 326, 336. As apparent from the order of the TxRx: ON, Tx: OFF Rx: ON, and TxRx: OFF arranged from top to bottom on the vertical axis, the power consumption of the modem units 325, 335 and the RF band units 326, 336 is given by the following relationship: TxRx: ON>Tx: OFF Rx: ON>TxRx: OFF.

It is to be noted that in the following description, the handover from 3G to WiMAX is referred to as hand-up, and the handover from WiMAX to 3G as hand-down.

Referring to FIG. 6, a detailed description will be given to the control switching of the wireless transmission/reception units in the state transition from power ON to WiMAX waiting, with WiMAX as the priority network. In FIG. 6, the power is turned on to the hybrid communication terminal 300 with WiMAX as the priority network. Then, the hybrid communication terminal 300 first performs 3G protocol process, and obtains position registration process and system time. At this time, the 3G modem unit 325 and the 3G RF band unit 326 are in the TxRx: ON state. On the other hand, the WiMAX modem unit 335 and the WiMAX RF band unit 336 are in the TxRx: OFF state. Next, the hybrid communication terminal 300 performs WiMAX scan. The WiMAX scan is a process for scanning the used frequencies of 2620 MHz, 2610 MHz, and 2600 MHz, and capturing the 10 MHz band with the highest value of the carrier power to interference power and noise power ratio (CINR). At this time, the 3G modem unit 325 and the 3G RF band unit 326 are in the TxRx: OFF state. On the other hand, the WiMAX modem unit 335 and the WiMAX RF band unit 336 are in the TxRx: ON state.

The hybrid communication terminal 300 moves to WiMAX monitoring. At this time, the 3G modem unit 325 and the 3G RF band unit 326 are in the TxRx: OFF state. On the other hand, the WiMAX modem unit 335 and the WiMAX RF band unit 336 are in the TxRx: ON state. The hybrid communication terminal 300 performs 3G monitoring for 1 second every 30 seconds during the WiMAX monitoring phase. Then, the hybrid communication terminal 300 performs 3G scan to display the electric field. The 3G scan is a process similar to the WiMAX scan described above. At this time, the 3G modem unit 325 and the 3G RF band unit 326, as well as the WiMAX modem unit 335 and the WiMAX RF band unit 336 are all in the Tx: OFF Rx: ON state.

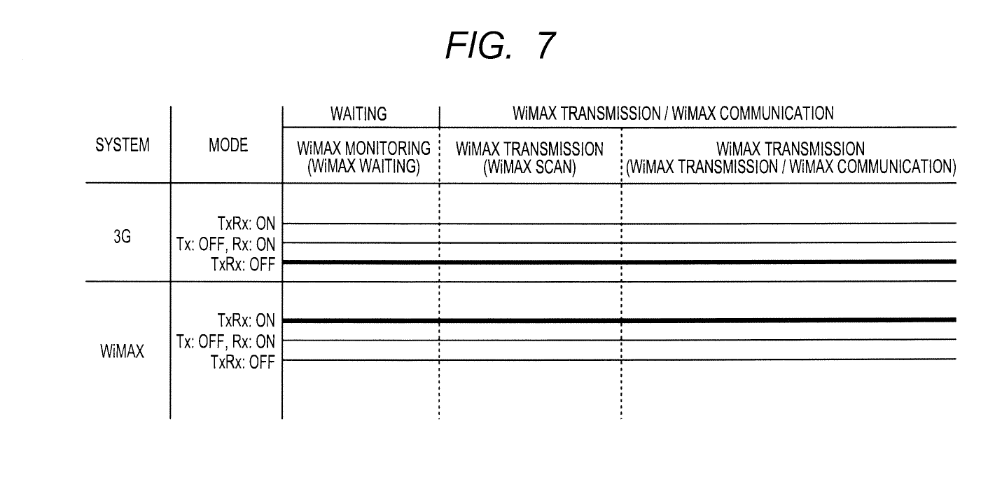

Referring to FIG. 7, a detailed description will be given to the control switching of the wireless transmission/reception units in the state transition from WiMAX communication to 3G communication with WiMAX as the priority network. In FIG. 7, the hybrid communication terminal 300 in the waiting state receives a transmission operation, and performs WiMAX scan for WiMAX transmission. The WiMAX scan for WiMAX transmission is the process for determining whether WiMAX is captured, and performing the transmission as long as it is determined to be captured. When WiMAX fails to be captured, the hybrid communication terminal 300 performs the WiMAX scan again to capture it. The hybrid communication terminal 300 performs the WiMAX transmission, and moves to WiMAX communication. During this process phase, the 3G modem unit 325 and the 3G RF band unit 326 are in the TxRx: OFF state. On the other hand, the WiMAX modem unit 335 and the WiMAX RF band unit 336 are in the TxRx: ON state.

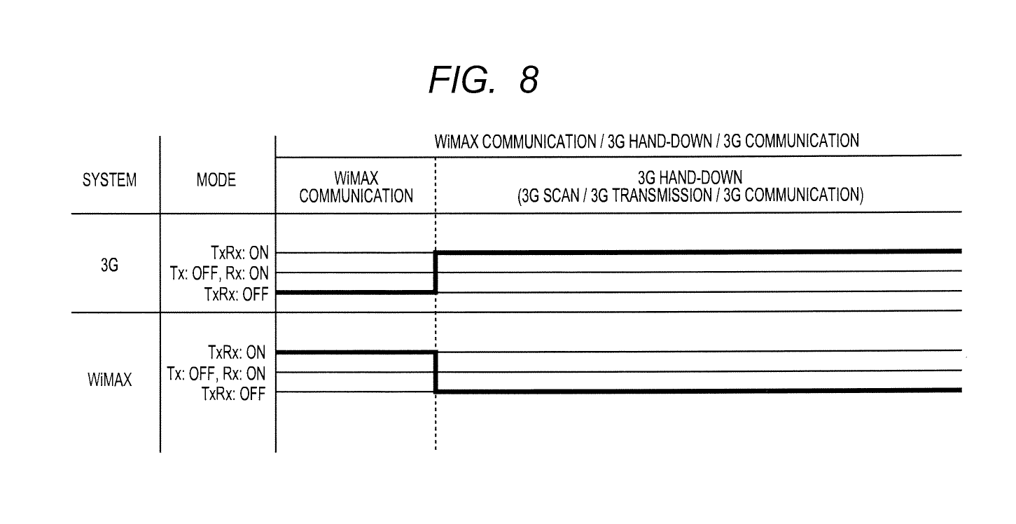

Referring to FIG. 8, a detailed description will be given to the control switching of the wireless transmission/reception units in the state transmission from WiMAX communication to 3G communication with WiMAX as the priority network. In FIG. 8, the hybrid communication terminal 300 in the WiMAX communication state hands down to the 3G for some reason. The hand-down process has the following three states: 3G scan, 3G transmission, and 3G communication. In the hand-down process, the 3G modem unit 325 and the 3G RF band unit 326 are in the TxRx: ON state. On the other hand, the WiMAX modem unit 335 and the WiMAX RF band unit 336 are in the TxRx: OFF state.

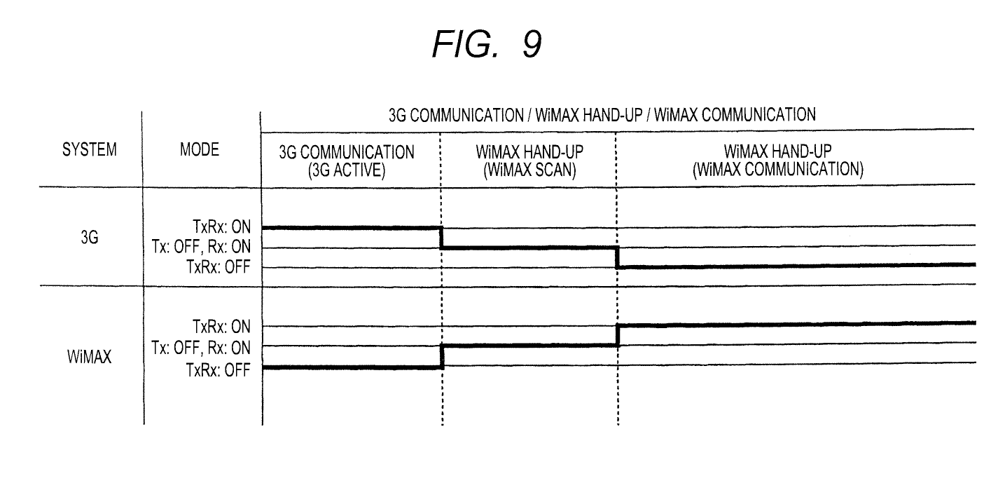

Referring to FIG. 9, a detailed description will be given to the control switching of the wireless transmission/reception units in the state transition from 3G communication to WiMAX communication with WiMAX as the priority network. In FIG. 9, the hybrid communication terminal 300 in the 3G communication state for some reason starts WiMAX scan. Here, WiMAX is successfully captured, so that the hybrid communication terminal 300 moves to WiMAX communication.

During the 3G communication, the 3G modem unit 325 and the 3G RF band unit 326 are in the TxRx: ON state. On the other hand, the WiMAX modem unit 335 and the WiMAX RF band unit 336 are in the TxRx: OFF state. During the WiMAX scan process, the 3G modem unit 325 and the 3G RF band unit 326 as well as the WiMAX modem unit 335 and the WiMAX RF band unit 336 are all in the Tx: OFF Rx: ON state. During the WiMAX waiting, the 3G modem unit 325 and the 3G RF band unit 326 are in the TxRx: OFF state. On the other hand, the WiMAX modem unit 335 and the WiMAX RF band unit 336 are in the TxRx: ON state.

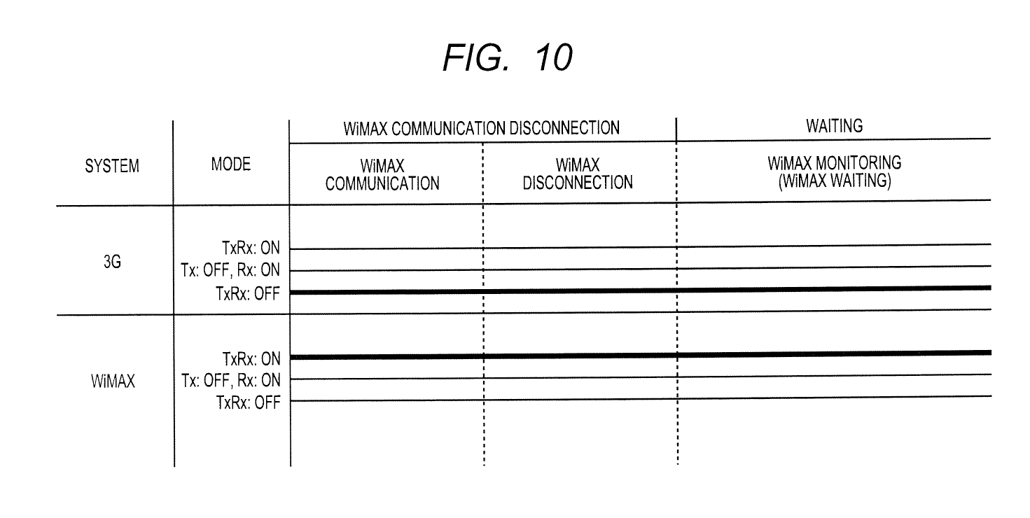

Referring to FIG. 10, a detailed description will be given to the control switching of the wireless transmission/reception units in the state transmission from WiMAX communication to WiMAX waiting, with WiMAX as the priority network. In FIG. 10, the hybrid communication terminal 300 in the WiMAX communication state moves to WiMAX waiting as the priority network, through WiMAX disconnection. During this process phase, the 3G modem unit 325 and the 3G RF band unit 326 are in the TxRx: OFF state. On the other hand, the WiMAX modem unit 335 and the WiMAX RF band unit 336 are in the TxRx: ON state.

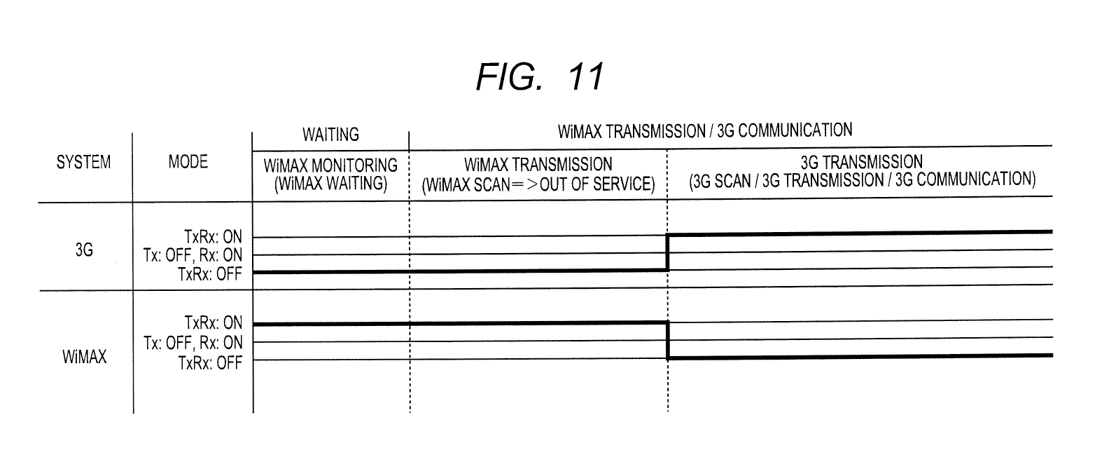

Referring to FIG. 11, a detailed description will be given to the control switching of the wireless transmission/reception units in the state transition from WiMAX waiting to 3G communication through WiMAX communication failure, with WiMAX as the priority network. In FIG. 11, the hybrid communication terminal 300 in the WiMAX waiting state receives a transmission operation, and performs WiMAX scan. However, the hybrid communication terminal 300 determines to be out of WiMAX service. Thus, the hybrid communication terminal 300 switches to 3G transmission. The hybrid communication terminal 300 moves to the 3G communication state through 3G scan and 3G transmission.

During the WiMAX waiting and WiMAX scan phases, the 3G modem unit 325 and the 3G RF band unit 326 are in the TxRx: OFF state. On the other hand, the WiMAX modem unit 335 and the WiMAX RF band unit 336 are in the TxRx: ON state. In the 3G transmission, 3G modem unit 325 and the 3G RF band unit 326 are in the TxRx: ON state. On the other hand, the WiMAX modem unit 335 and the WiMAX RF band unit 336 are in the TxRx: OFF state.

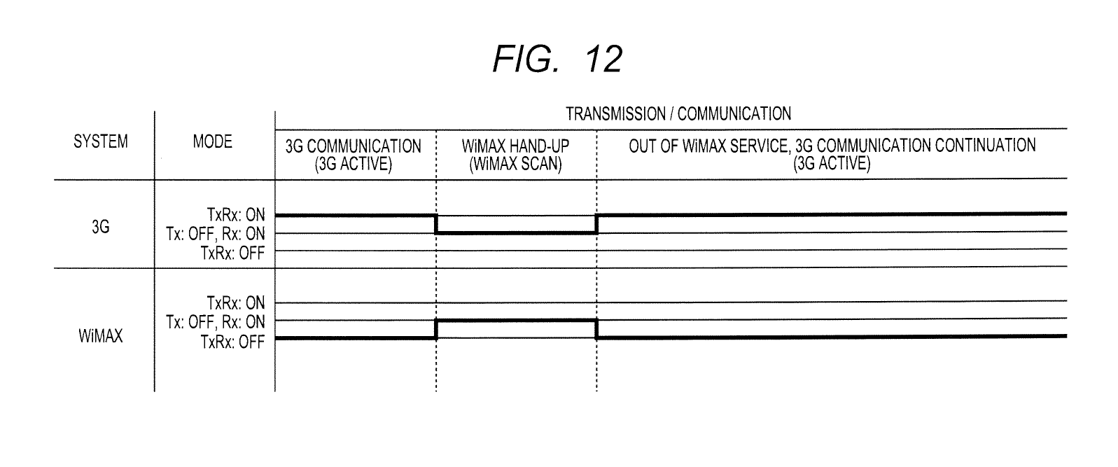

Referring to FIG. 12, a detailed description will be given to the control switching of the wireless transmission/reception units in the state transition from 3G communication to 3G communication again through WiMAX hand-up, with WiMAX as the priority network. In FIG. 12, the process from 3G active to WiMAX hand-up is the same as the process shown in FIG. 9. However, the hybrid communication terminal 300 detects to be out of WiMAX service in the WiMAX hand-up process. Thus, the hybrid communication terminal 300 selects 3G communication continuation. During the WiMAX scan phase, the 3G modem unit 325 and the 3G RF band unit 326 as well as the WiMAX modem unit 335 and the WiMAX RF band unit 336 are all in the Tx: OFF Rx: ON state. In the other process phases, the 3G modem unit 325 and the 3G RF band unit 326 are in the TxRx: ON state. On the other hand, the WiMAX modem unit 335 and the WiMAX RF band unit 336 are in the TxRx: OFF state.

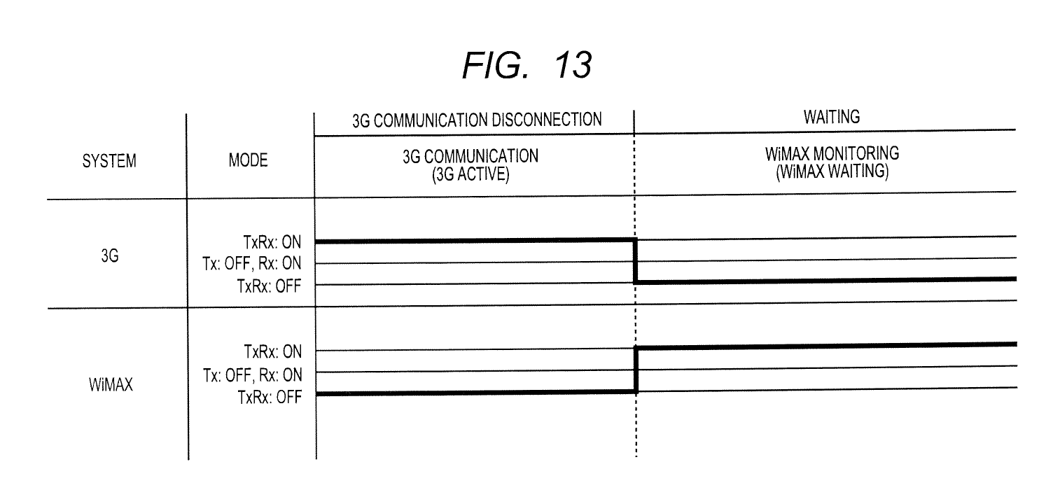

Referring to FIG. 13, a detailed description will be given to the control switching of the wireless transmission/reception units in the state transition from 3G communication to WiMAX waiting, with WiMAX as the priority network. In FIG. 13, the hybrid communication terminal 300 in the 3G communication state for some reason disconnects the 3G communication, and moves to WiMAX waiting. During the 3G communication phase, the 3G modem unit 325 and the 3G RF band unit 326 are in the TxRx: ON state. On the other hand, the WiMAX modem unit 335 and the WiMAX RF band unit 336 are in the TxRx: OFF state. During the WiMAX waiting phase, the 3G modem unit 325 and the 3G RF band unit 326 are in the TxRx: OFF state. On the other hand, the WiMAX modem unit 335 and the WiMAX RF band unit 336 are in the TxRx: ON state.

More specifically, the state transition from 3G communication to WiMAX waiting is made through WiMAX scan. However, the description focuses on the control switching of the wireless transmission/reception units, so that the WiMAX scam is omitted here.

Referring to FIG. 14, a detailed description will be given to the control switching of the wireless transmission/reception units in the state transition from power ON to 3G waiting, with 3G as the priority network. In FIG. 14, when the power is turned ON to the hybrid communication terminal 300 with 3G as the priority network, the hybrid communication terminal 300 first performs WiMAX scan. Next, the hybrid communication terminal 300 performs 3G protocol process, and moves to 3G monitoring. The hybrid communication terminal 300 performs WiMAX monitoring for 1 second every 30 seconds during the 3G monitoring phase, and performs WiMAX scan to display the electric field. The Hybrid communication terminal 300 performs 3G protocol process on an irregular basis. In the irregular 3G protocol process, the hybrid communication terminal 300 performs the protocol process such as idle hand-off.

During the WiMAX scan phase, the 3G modem unit 325 and the 3G RF band unit 326 are in the TxRx: OFF state. On the other hand, the WiMAX modem unit 335 and the WiMAX RF band unit 336 are in the TxRx: ON state. During the 3G protocol process and 3G monitoring phases, the 3G modem unit 325 and the 3G RF band unit 326 are in the TxRx: ON state. On the other hand, the WiMAX modem unit 335 and the WiMAX RF band unit 336 are in the TxRx: OFF state. During the WiMAX monitoring phase, the 3G modem unit 325 and the 3G RF band unit 326, as well as the WiMAX modem unit 335 and the WiMAX RF band unit 336 are all in the Tx: OFF Rx: ON state.

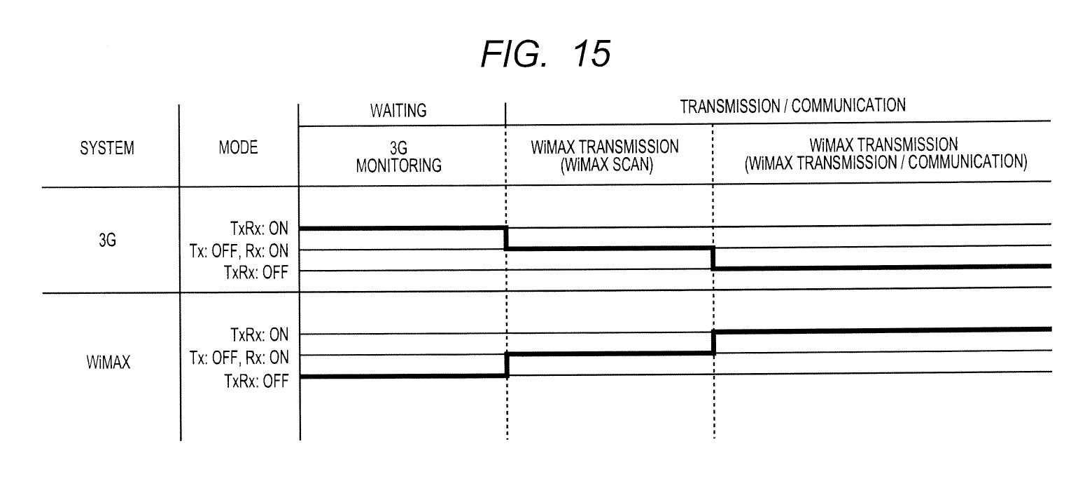

Referring to FIG. 15, a detailed description will be given to the control switching of the wireless transmission/reception unit in the state transition from 3G waiting to WiMAX transmission, with 3G as the priority network. In FIG. 15, the hybrid communication terminal 300 in the 3G waiting state receives a WiMAX transmission, and starts WiMAX scan. In this case, the WiMAX is successfully captured. Thus, the hybrid communication terminal 300 performs WiMAX transmission and starts WiMAX communication.

During the 3G waiting phase, the 3G modem unit 325 and the 3G RF band unit 326 are in the TxRx: ON state. On the other hand, the WiMAX modem unit 335 and the WiMAX RF band unit 336 are in the TxRx: OFF state. During the WiMAX scan phase, the 3G modem unit 325 and the 3G RF band unit 326 as well as the WiMAX modem unit 335 and the WiMAX RF band unit 336 are all in the Tx: OFF Rx: ON state. After the WiMAX transmission, the 3G modem unit 325 and the 3G RP band unit 326 are in the TxRx: OFF state. On the other hand, the WiMAX modem unit 335 and the WiMAX RF band unit 336 are in the TxRx: ON state.

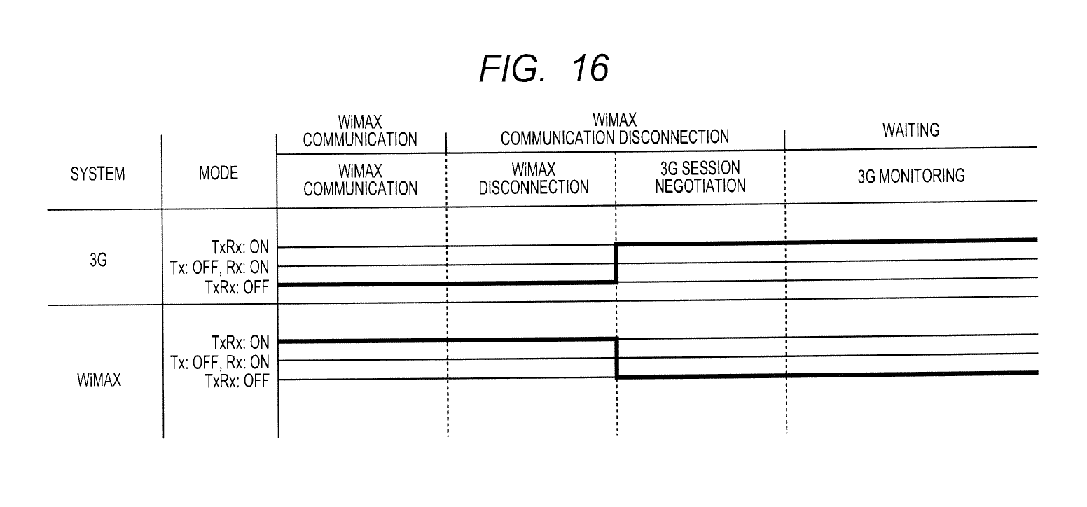

Referring to FIG. 16, a detailed description will be given to the control switching of the wireless transmission/reception units in the state transition from WiMAX communication to 3G waiting, with 3G as the priority network. In FIG. 16, the hybrid communication terminal 300 in the WiMAX communication state for some reason moves to 3G waiting through WiMAX disconnection and 3G session negotiation. During the WiMAX communication and WiMAX disconnection phases, the 3G modem unit 325 and the 3G RF band unit 326 are in the TxRx: OFF state. On the other hand, the WiMAX modem unit 335 and the WiMAX RF band unit 336 are in the TxRx: ON state. During the 3G session negotiation and 3G waiting phases, the 3G modem unit 325 and the 3G RF band unit 326 are in the TxRx: ON state. On the other hand, the WiMAX modem unit 335 and the WiMAX RF band unit 336 are in the TxRx: OFF state.

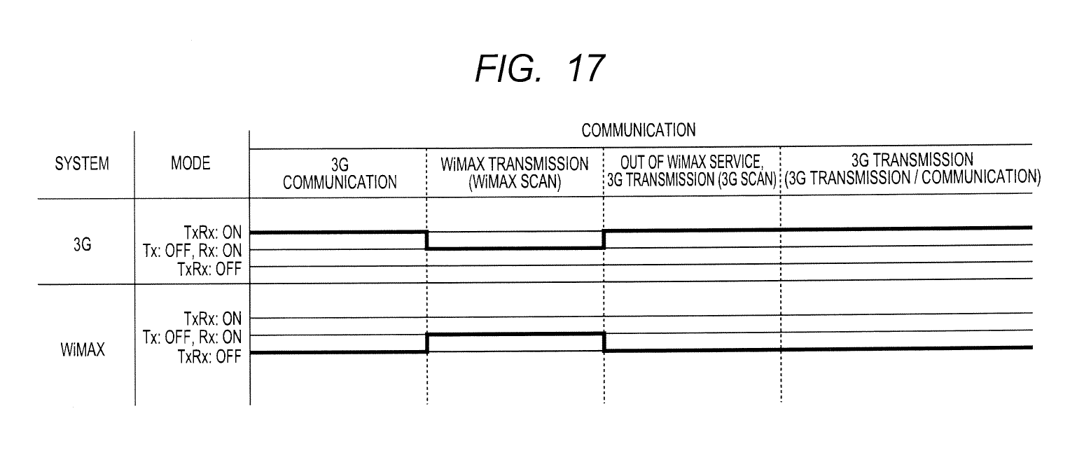

Referring to FIG. 17, a detailed description will be given to the control switching of the wireless transmission/reception units in the state transition from 3G communication to 3G communication again through WiMAX scan, with 3G as the priority network. In FIG. 17, the hybrid communication terminal 300 in the 3G communication state tries WiMAX transmission. However, it is determined to be out of WiMAX service, so that the hybrid communication terminal 300 changes to 3G transmission. Then, the hybrid communication terminal 300 performs the 3G transmission through 3G scan.

During the WiMAX scan phase, the 3G modem unit 325 and the 3G RF band unit 326 as well as the WiMAX modem unit 335 and the WiMAX RF band unit 336 are all in the Tx: OFF Rx: ON state. In the other process phases, the 3G modem unit 325 and the 3G RF band unit 326 are in the TxRx: ON state. On the other hand, the WiMAX modem unit 335 and the WiMAX RF band unit 336 are in the TxRx: OFF state.

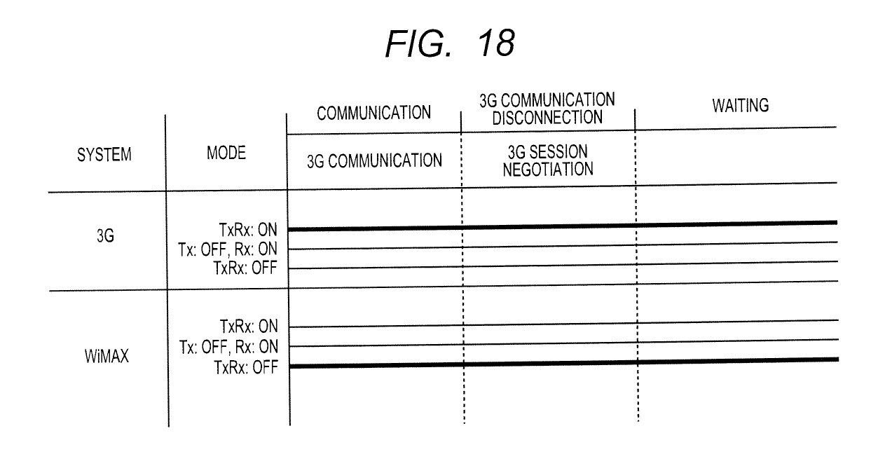

Referring to FIG. 18, a detailed description will be given to the control switching of the wireless transmission/reception units in the state transition from 3G communication to 3G waiting, with 3G as the priority network. In FIG. 18, the hybrid communication terminal 300 in the 3G communication state disconnects the 3G communication. Then, the state moves to 3G waiting. In all process phases of FIG. 18, the 3G modem unit 325 and the 3G RF band unit 326 are in the TxRx: ON state. On the other hand, the WiMAX modem unit 335 and the WiMAX RF band unit 336 are in the TxRx: OFF state.

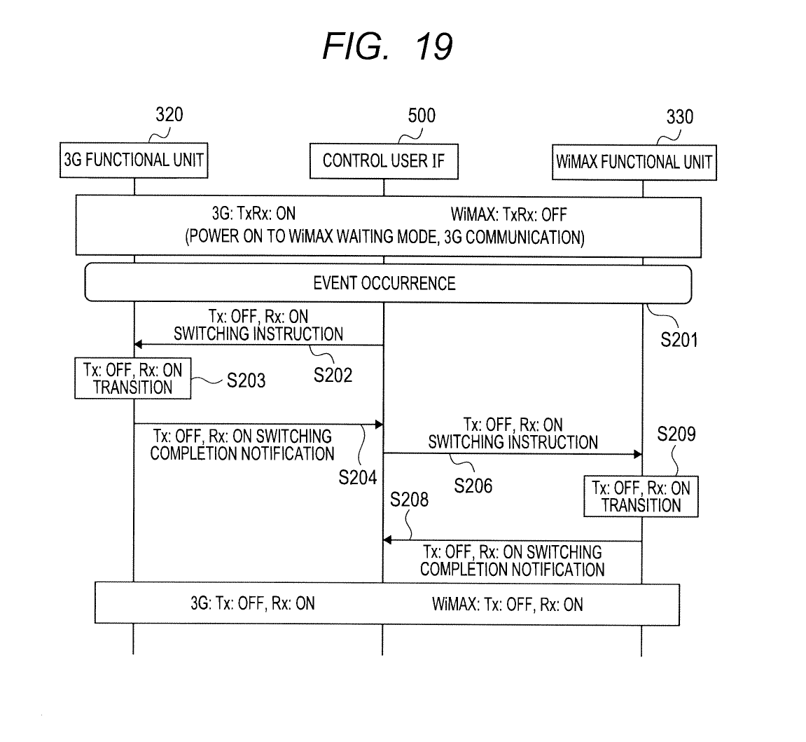

The RF control sequence of the 3G functional unit 320, the system handover control user interface 500, and the WiMAX functional unit 330 will be described with reference to FIGS. 19 to 24. In FIGS. 19 to 24, the description will be given assuming that WiMAX is in the waiting state. The RF control sequence in the 3G waiting state can easily be understood by those skilled in the art through the description of FIGS. 19 to 24.

In FIG. 19, the 3G functional unit 320, the system handover control user interface 500, and the WiMAX functional unit 330 are in the TxRx: ON state with respect to 3G, and in the TxRx: OFF state with respect to WiMAX. This occurs after power ON to the WiMAX priority mode, and 3G waiting. In this state, the 3G functional unit 320, the system handover control user interface 500, and the WiMAX functional unit 330 detect an event occurrence (S201). Here, the event includes the following three events:

WiMAX scan during 3G waiting;
WiMAX scan in 3G priority mode transmission; and
WiMAX scan in 3G (Dormant)-WiMAX hand-up

The control user interface 500 transmits an instruction to the 3G functional unit 320 to switch to Tx: OFF Rx: ON (S202). The 3G functional unit 320 moves to Tx: OFF Rx: ON (S203). The 3G functional unit 320 transmits a notification of Tx: OFF Rx: ON switching completion to the control user interface 500 (S204). The control user interface 500 transmits an instruction to the WiMAX functional unit 330 to switch to Tx: OFF Rx: ON (S206). The WiMAX functional unit 330 moves to Tx: OFF Rx: ON (S207). The WiMAX functional unit 330 transmits a notification of Tx: OFF Rx: ON switching completion to the control user interface 500 (S208). As a result, the 3G functional unit 320, the system handover control user interface 500, and the WiMAX functional unit 330 move to Tx: OFF Rx: ON with respect to both 3G and WiMAX.

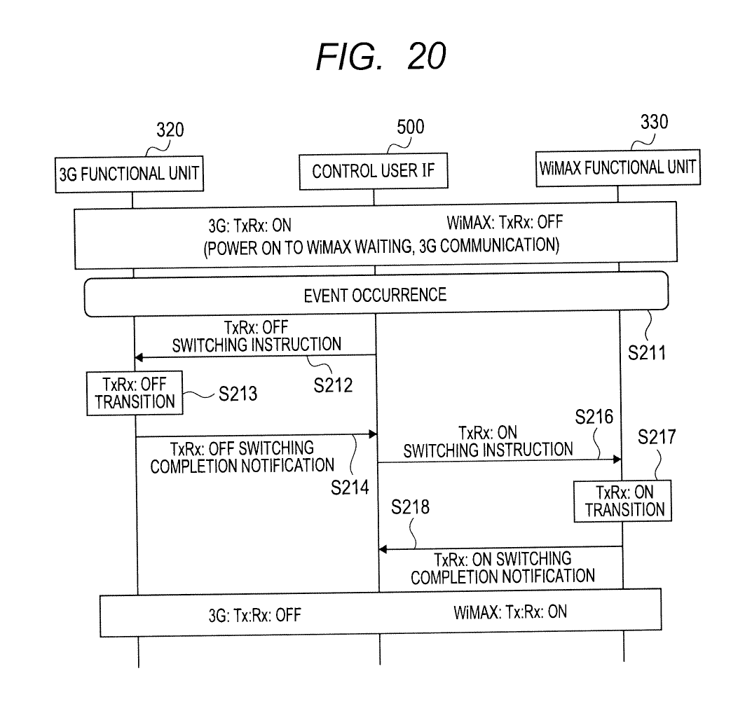

In FIG. 20, the 3G functional unit 320, the system handover control user interface 500, and the WiMAX functional unit 330 are in the TxRx: ON state with respect to 3G, and in the TxRx: OFF state with respect to WiMAX. This occurs after power ON to the WiMAX priority mode, and 3G communication. In this state, the 3G functional unit 320, the system handover control user interface 500, and the WiMAX functional unit 330 detect an event occurrence (S211). Here the event includes the following two events:

Power ON to the WiMAX priority mode (3G scan to WiMAX waiting); and
Disconnection during 3G communication in the WiMAX priority mode

The control user interface 500 transmits an instruction to the 3G functional unit 320 to switch to TxRx: OFF (S212). The 3G functional unit 320 moves to the TxRx: OFF state (S213). The 3G functional unit 320 transmits a notification of TxRx: OFF switching completion to the control user interface 500 (S214). The control user interface 500 transmits an instruction to the WiMAX functional unit 330 to switch to TxRx: ON (S216). The WiMAX functional unit 330 moves to the TxRx: ON state (S217). The WiMAX functional unit 330 transmits a notification of TxRx: ON switching completion to the control user interface 500 (S218). As a result, the 3G functional unit 320, the system handover control user interface 500, and the WiMAX functional unit 330 move to the TxRx: OFF state with respect to 3G, and to the TxRx: ON state with respect to WiMAX.

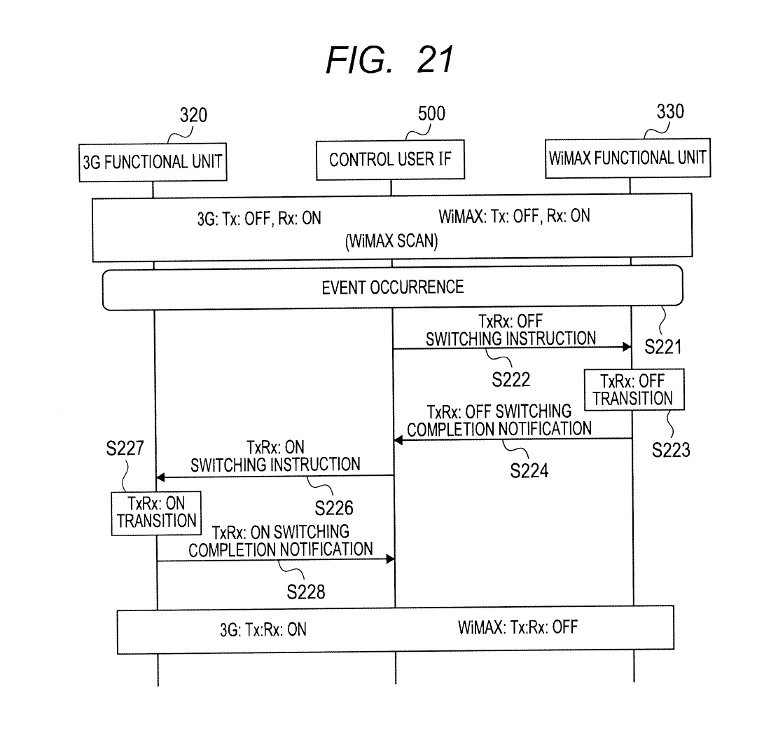

In FIG. 21, the 3G functional unit 320, the system handover control user interface 500, and the WiMAX functional unit 330 are in the Tx: OFF Rx: ON state with respect to both 3G and WiMAX. This occurs during the WiMAX scan phase. In this state, the 3G functional unit 320, the system handover control user interface 500, and the WiMAX functional unit 330 detect an event occurrence (S221). Here, the event includes the following three events:

WiMAX scan end in the 3G priority mode;
3G transmission in 3G waiting; and
Out of WiMAX service scan end during 3G communication (3G_Dormant continuation)

The control user interface 500 transmits an instruction to the WiMAX functional unit 330 to switch to TxRx: OFF (S222). The WiMAX functional unit 330 moves to the TxRx: OFF state (S223). The WiMAX functional unit 330 transmits a notification of TxRx: OFF switching completion to the control user interface 500 (S224). The control user interface 500 transmits an instruction to the 3G functional unit 320 to switch to TxRx: ON (S226). The 3G functional unit 320 moves to the TxRx: ON state (S227). The 3G functional unit 320 transmits a notification of TxRx: ON switching completion to the control user interface 500 (S228). As a result, the 3G functional unit 320, the system handover control user interface 500, and the WiMAX functional unit 330 move to the TxRx: ON state with respect to 3G, and to the TxRx: OFF state with respect to WiMAX.

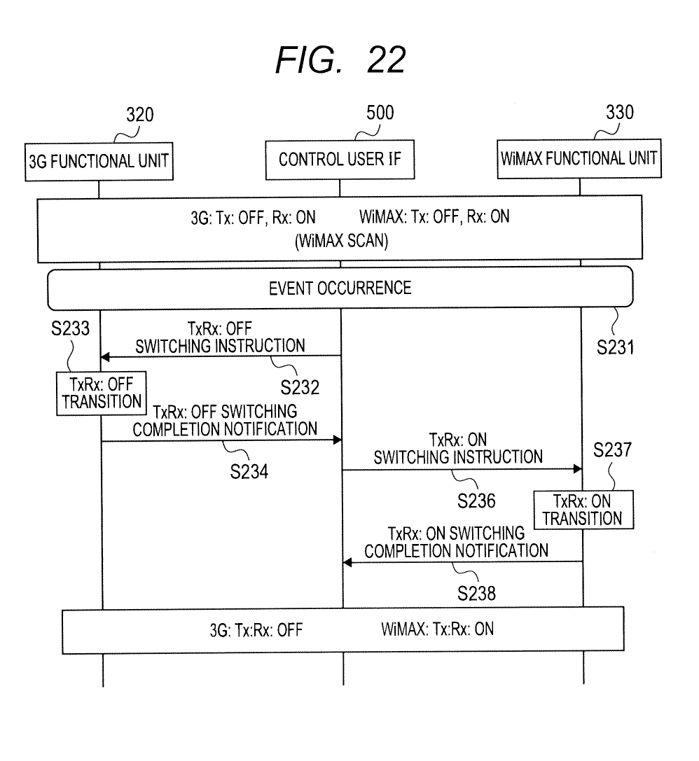

In FIG. 22, the 3G functional unit 320, the system handover control user interface 500, and the WiMAX functional unit 330 are in the Tx: OFF Rx: ON state with respect to both 3G and WiMAX. This occurs during the WiMAX scan phase. In this state, the 3G functional unit 320, the system handover control user interface 500, and the WiMAX functional unit 330 detect an event occurrence (S231). Here, the event includes the following three events:

3G scan end in the WiMAX priority mode;
WiMAX transmission after WiMAX scan in the 3G priority mode; and
WiMAX hand-up after WiMAX scan in 3G communication

The control user interface 500 transmits an instruction to the 3G functional unit 320 to switch to TxRx: OFF (S232). The 3G functional unit 320 moves to the TxRx: OFF state (S233). The 3G functional unit 320 transmits a notification of TxRx: OFF switching completion to the control user interface 500 (S234). The control user interface 500 transmits an instruction to the WiMAX functional unit 330 to switch to TxRx: ON (S236). The WiMAX functional unit 330 moves to the TxRx: ON state (S237). The WiMAX functional unit 330 transmits a notification of TxRx: ON switching completion to the control user interface 500 (S238). As a result, the 3G functional unit 320, the system handover control user interface 500, and the WiMAX functional unit 330 move to the TxRx: OFF state with respect to 3G and to the TxRx: ON state with respect to WiMAX.

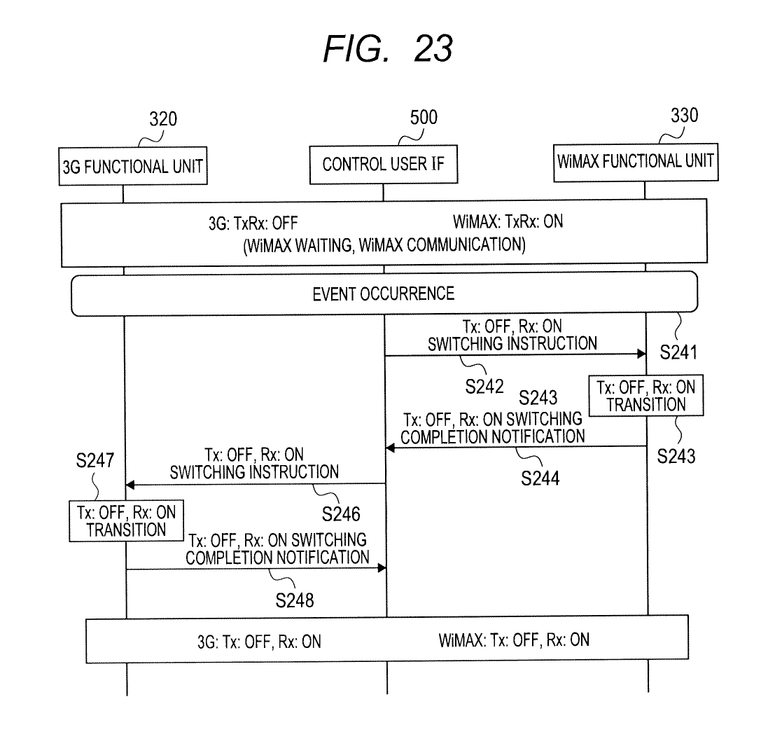

In FIG. 23, the 3G functional unit 320, the system handover control user interface 500, and the WiMAX functional unit 330 are in the TxRx: OFF state with respect to 3G, and in the TxRx: ON state with respect to WiMAX. This occurs during the WiMAX waiting and WiMAX communication phases. In this state, the 3G functional unit 320, the system handover control user interface 500, and the WiMAX functional unit 330 detect an event occurrence (S241). Here, the event includes the following one event:

3G scan in the WiMAX priority mode.

The control user interface 500 transmits an instruction to the WiMAX functional unit 330 to switch to Tx: OFF Rx: ON (S242). The WiMAX functional unit 330 moves to the Tx: OFF Rx: ON state (S243). The WiMAX functional unit 330 transmits a notification of Tx: OFF Rx: ON switching completion to the control user interface 500 (S244). The control user interface 500 transmits an instruction to the 3G functional unit 320 to switch to Tx: OFF Rx: ON (S246). The 3G functional unit 320 moves to the Tx: OFF Rx: ON state (S247). The 3G functional unit 320 transmits a notification of Tx: OFF Rx: ON switching completion to the control user interface 500 (S248). As a result, the 3G functional unit 320, the system handover control user interface 500, and the WiMAX functional unit 330 move to the Tx: OFF Rx: ON state with respect to both 3G and WiMAX.

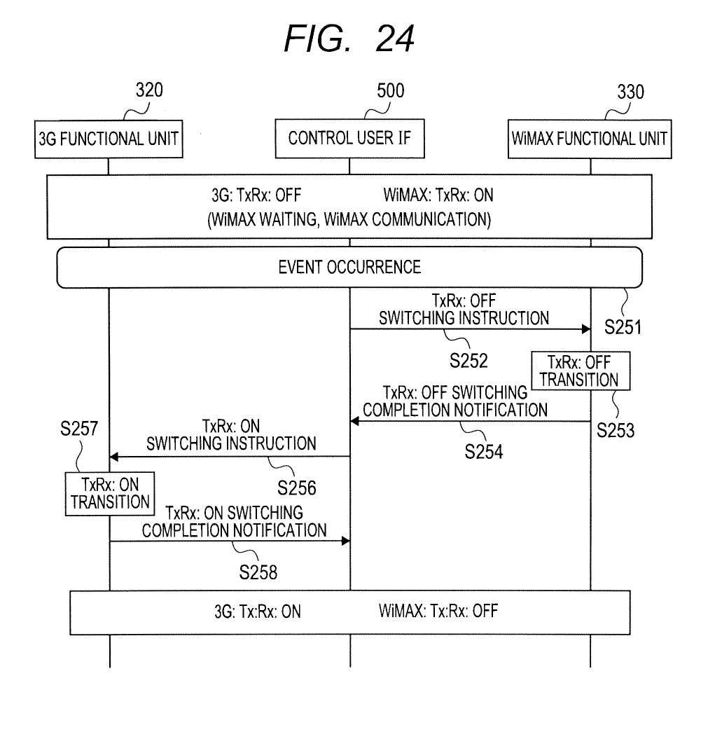

In FIG. 24, the 3G functional unit 320, the system handover control user interface 500, and the WiMAX functional unit 330 are in the TxRx: OFF state with respect to 3G, and in the TxRx: ON sate with respect to WiMAX. This occurs during the WiMAX waiting and WiMAX communication phases. In this state, the 3G functional unit 320, the system handover control user interface 500, and the WiMAX functional unit 330 detect an event occurrence (S251). Here, the event includes the following three events:

3G transmission in the WiMAX priority mode;
WiMAX-3G hand-down; and
Disconnection during WiMAX communication in the 3G priority mode

The control user interface 500 transmits an instruction to the WiMAX functional unit 330 to switch to TxRx: OFF (S252). The WiMAX functional unit 330 moves to the TxRx: OFF state (S253). The WiMAX functional unit 330 transmits a notification of TxRx: OFF switching completion to the control user interface 500 (S254). The control user interface 500 transmits an instruction to the 3G functional unit 320 to switch to TxRx: ON (S256). The 3G functional unit 320 moves to the TxRx: ON state (S257). The 3G functional unit 320 transmits a notification of TxRx: On switching completing to the control user interface 500 (S258). As a result, the 3G functional unit 320, the system handover control user interface 500, and the WiMAX functional unit 330 move to the TxRx: ON state with respect to 3G and to the TxRx: OFF state with respect to WiMAX.

As apparent from FIGS. 19 to 24, according to the present embodiment, the control user interface 500 first transmits a switching instruction to the functional unit 320/330 on the side in which the function of the modem unit and the RF band unit is deactivated, waiting for the completion of the switching. Then, the control user interface 500 transmits a switching instruction to the functional unit 320/330 on the side in which the function of the modem unit and the RF band unit is activated. As a result, in the communication terminal operated by power supplied from the PC, a large number of PC interfaces can be supported. Further, even in the communication terminal of handset type not receiving power supply from the PC, the total amount of power consumption is reduced. As a result, it is possible to increase the lifetime of the built-in battery of the communication terminal.

What is claimed is:

1. A hybrid communication terminal capable of connecting to a first wireless network and a second wireless network, and of controlling a handover from the first wireless network to the second wireless network, the hybrid communication terminal comprising:
a first functional unit for connecting to the first wireless network;
a second functional unit for connecting to the second wireless network; and
a hub for connecting the first and second functional units to a computer,
wherein the first and second functional units obtain connection states to the first and second wireless networks, respectively, and
wherein the first and second functional units transmit the obtained connection states to the computer, respectively.

2. The hybrid communication terminal according to claim 1,
wherein the first and second functional units each include an RF band unit, a modem unit, and a power management unit,
wherein the power management unit, the RF band unit, and the modem unit are non-selective in the first and second functional units, and
wherein the power management unit deactivates at least a part of the RF band unit and of the modem unit.

3. The hybrid communication terminal according to claim 1, wherein one of the first and second functional units has been registered as a priority system.

4. A program for causing a computer to function as:
a state monitoring unit for a first network;
a state monitoring unit for a second network; and
a handover controller for determining and controlling a handover from the first network to the second network, based on a first determination result of the state monitoring unit for the first network, and based on a second determination result of the state monitoring unit for the second network.

5. A hybrid communication terminal capable of simultaneously connecting to a first wireless network and a second wireless network, the hybrid communication terminal comprising:
a first modem unit and a first RF band unit for connecting to the first wireless network; and
a second modem unit and a second RF band unit for connecting to the second wireless network,
wherein in a state of waiting for the first wireless network, the hybrid communication terminal deactivates transmission units of the first modem unit and the first RF band unit while activating reception units of the second modem unit and the second RF and unit, to monitor a state of the second wireless network.
